(19) United States
(12) Patent Application Publication
(10) Pub. No.: US 2018/0310630 A1
(43) Pub. Date: Nov. 1, 2018

(54) ELECTRONIC CIGARETTE AS PERSONAL VAPORIZER AND ASSOCIATED "MOD" DEVICE

(71) Applicant: FAST EDDIE'S VAPE SHOP AND LOUNGE,LLC, Orlando, FL (US)

(72) Inventor: Matthew R. Kleizo, Longwood, FL (US)

(21) Appl. No.: 16/029,730

(22) Filed: Jul. 9, 2018

Related U.S. Application Data
(63) Continuation-in-part of application No. 15/921,926, filed on Mar. 15, 2018.
(60) Provisional application No. 62/473,713, filed on Mar. 20, 2017.

(51) Int. Cl. A24F 47/00; H05B 3/42

(52) U.S. Cl. CPC A24F 47/008; H05B 3/42

(57) ABSTRACT

A personal vaporizer mod device has a hybrid sleeve as a female tube member that receives a male tube member. A switch is at the lower end of the male tube member which when closed, completes an electrical circuit from the battery into the male and female tube members and into a rebuildable atomizer deck supported by the female tube member. A firing pin is received on a shaft of a button member and engages a battery contact of the battery when the button member is depressed, and includes a first magnet of a first polarity and a second magnet having a polarity such that the button member is repelled in a direction outward from the button housing containing the button member. A firing pin stop retains the button member within the button housing.

### PRIORITY APPLICATION(S)

This is a continuation-in-part application based on U.S. patent application Ser. No. 15/921,926 filed Mar. 15, 2018, which is based on U.S. provisional patent application Ser. No. 62/473,713 filed Mar. 20, 2017, the disclosures which are hereby incorporated by reference in their entirety.

### FIELD OF THE INVENTION

This invention relates to electronic cigarettes formed as personal vaporizers, and more particularly, this invention relates to an electronic cigarette formed as a personal vaporizer and a “mod” device that supports a rebuildable atomizer, such as a rebuildable dripping atomizer (RDA).

### BACKGROUND OF THE INVENTION

Electronic cigarettes have become very popular in the last few years. Many of these electronic cigarettes operate as a battery-powered vaporizer that includes a mouth piece, a rebuildable device or deck, a juice or e-liquid that is vaporized and a heating element or similar atomizer. The heating element is typically a heating coil and heats and vaporizes the juice. A wicking material helps draw the juice or liquid onto the coil such as from a well that holds the juice. In some devices, the user manually depresses a button on the side of the housing or at the end of the device to close a switch and actuate a contact button or “firing pin” or other contact device to complete the electronic circuit between the battery and the atomizer.

The electronic cigarette designs currently in use vary and recent design modifications include mechanical “mods,” for example, that may have a rebuildable atomizer deck that allows a user to assemble or “build” the wick and coil themselves, instead of using off-the-shelf atomizer “heads.” These types of devices are often termed a rebuildable dripping atomizer (RDA), or sometimes referred to as a “dripper.” Experienced users of electronic cigarettes enjoy building their atomizers because they can choose a specific configuration and electrical resistance of their coil, and thus, pick their flavor and the amount of aerosolized vapor produced by the electronic cigarette. In the rebuildable dripping atomizer, the juice is usually dripped directly onto the coil and the wick. The liquid or juice used in these systems generally has vegetable glycerin or propylene glycol and may include flavoring. The RDA “building deck” or “deck” usually has two or three or more posts with holes formed in them that accept one or more coils. The user typically maintains the wick wet by dripping liquid onto the bare wick and coil and/or drawing juice from a well. Often a well-built RDA will last as many as 10 to 20 puffs and emit very large quantities of vapor.

When rebuilding the RDA decks, there is usually a positive post in the center and one or more negative posts located outside the center. One end or lead of the coil is attached to the positive post and the other lead of the coil is attached to one of the negative posts. This process is repeated on opposing sides if two coils are used. In some devices, air flow control can be maintained by spinning a top piece to close off the air holes or open them wide. The number of holes can vary so that the atomizer is used efficiently with one or two or more coils and the holes are lined up adjacent the coils. With a single coil, the RDA operates in a single coil mode, but with two coils, the RDA operates in a dual coil mode.

Building the coils typically requires a user to select the type of wire and its gauge. In one example, the user wraps the wire around a cylindrical object to form the coil and then inserts the coil within the negative or positive leads in order to make a “build.” Often the device configuration does not permit an efficient electrical connection and makes the build difficult. Some designs are even clumsy to use after the build.

### SUMMARY OF THE INVENTION

This summary is provided to introduce a selection of concepts that are further described below in the Detailed Description. This summary is not intended to identify key or essential features of the claimed subject matter, nor is it intended to be used as an aid in limiting the scope of the claimed subject matter.

A personal vaporizer mod device comprises a cylindrical housing comprising a female tube member formed of a metallic material and having a first closed end and opposing open end. A male tube member is formed of a metallic material and received within the female tube member. The first closed end of the female tube member has a substantially planar upper end and a medially located orifice configured to receive an atomizer pin of a rebuildable atomizer deck that is supported on the planar upper end of the female tube member. An example of the rebuildable atomizer deck is a rebuildable dripping atomizer. The male tube member has open opposing ends and an upper end that is received within the female tube member and lower end extending out the female tube member. The male tube member is configured to receive a battery having a battery contact that engages the atomizer pin for supplying electric current to the rebuildable atomizer deck for atomizing a vaping liquid.

A switch is positioned at the lower end of the male tube member which when closed, completes an electrical circuit from the battery into the male and female tube members and into the rebuildable atomizer deck. The switch comprises a button housing received within the lower end of the male tube member and has a first orifice section of first diameter, and second orifice section of a second diameter less than the first diameter. A button member is received within the first orifice section. The button member has a shaft extending into the second orifice section and a firing pin received on the shaft that engages a battery contact of the battery when the button member is depressed. The button member further comprises an annular well and first magnet of a first polarity received therein. The button housing includes an internal annular groove in the second orifice section and at least one second magnet therein and having a polarity opposite the first magnet such that the button member is repelled in a direction outward from the button housing. A firing pin stop is formed in the button housing that engages the firing pin and retains the button member within the button housing.

Stand-offs may be positioned on the button housing that engage a battery received within the male tube member and create a gap between a battery contact and the firing pin. In an example, the button member may comprise a three-piece button member and include a base member having an orifice and an extension that receives the firing pin, a button screw member that includes a head having a predetermined configuration and shaft extending therefrom and received within the orifice in the base member, and an intermediate ring member interposed between the base member and the button screw member and including a slot having a configuration to match and receive the head of the button screw member. The base member and button screw member may be formed of a metallic material and the intermediate ring member may be formed from a plastic material.

In yet another example, the female tube member has openings that are configured to expose portions of the male tube member. The female tube member may include a design formed on its surface and the openings are configured in size and position to complement the design. The design formed on the surface may comprise a skull and the openings may correspond to the eyes of the skull. The lower end of the male tube member may abut against the female tube member and have an outer diameter about the same as the outer diameter of the female tube member.

In yet another example, the firing pin stop may comprise a button housing shoulder formed on the button housing within the second orifice section, and the firing pin includes a firing pin head having a lower annular ridge that engages the button housing shoulder. The firing pin stop may be configured such that a gap exists between the button housing and button member, allowing the button member to be depressed and move the firing pin upward into contact with a battery contact. The at least one second magnet may comprise two stacked magnets retained within the internal annular groove.

A battery adapter may be received within the male tube member and includes a battery contact to which the firing pin engages when the button member is depressed. The button member may include an outer planar surface that a user depresses, the outer planar surface including an ornamental design formed thereon. The button housing may include a first section received within the lower end of the male tube member and a second section that extends out of the lower end of the male tube member. The lower end of the male tube member and first section of the button housing may include respective threads, and the button housing when secured within the lower end of the male tube member forces a battery upward to engage the atomizer pin of a rebuildable atomizer deck.

In yet another example, a button assembly operative as a switch for a personal vaporizer mod device housing may comprise a button housing having a first section configured to be received within the lower end of a male tube member of a personal vaporizer mod device housing, and a second section that extends out of the lower end of the male tube member. The button housing has a first orifice section of first diameter and second orifice section of a second diameter less than the first diameter. A button member is received within the first orifice section. The button member has a shaft extending into the second orifice section and a firing pin received on the shaft that engages a battery contact of a battery when the button member is depressed. The button member may further comprise an annular well and first magnet of a first polarity received therein. The button housing may include an internal annular groove in the second orifice section and at least one second magnet therein and having a polarity opposite the first magnet such that the button member is repelled in a direction outward from the button housing. A firing pin stop is formed in the button housing that engages the firing pin and retains the button member within the button housing.

In yet still another example, a personal vaporizer mod device housing may comprise a female tube member formed of a metallic material and having a first closed end and opposing open end and a male tube member formed of a metallic material and received within the female tube member. The first closed end of the female tube member has a substantially planar upper end and a medially located orifice configured to receive an atomizer pin of a rebuildable atomizer deck that is supported on the planar upper end of the female tube member. The male tube member has open opposing ends and an upper end that is received within the female tube member and lower end extending out the female tube member. The male tube member is configured to receive a battery having a battery contact that engages an atomizer pin of a rebuildable atomizer deck that is supported on the planar upper end of the female tube member for supplying electric current to the rebuildable atomizer deck and atomizing a vaping liquid. The lower end of the male tube member is configured to receive a switch, which when closed, completes an electrical circuit from a battery into the male and female tube members and into the rebuildable atomizer deck supported on the female tube member.

### DESCRIPTION OF THE DRAWINGS

Other objects, features and advantages of the present invention will become apparent from the detailed description of the invention, which follows when considered in light of the accompanying drawings in which:

FIG. 1 is an isometric view of the electronic cigarette showing the RDA subassembly on the housing formed by the male and female tubes and the button assembly as a switch in accordance with a non-limiting example.

FIG. 2 is a front elevation view of the electronic cigarette of FIG. 1.

FIG. 3 is an exploded isometric view of the electronic cigarette of FIG. 1 showing the RDA subassembly, the male and female tubes, and the button assembly.

FIG. 4 is yet another exploded isometric view of the electronic cigarette shown at a different angle from that of FIG. 3.

FIG. 5 is a front sectional view of the electronic cigarette of FIG. 1 showing in greater detail the RDA subassembly, male and female tubes, battery and schematic representation of components in the button assembly.

FIG. 6 is a side sectional view of the assembled male and female tubes.

FIG. 7 is an isometric view of the assembled male and female tubes and showing a plurality of through-holes in the female tube to expose ornamental features that may be placed on the male tube.

FIG. 8 is a cut-away isometric view of the assembled male and female tubes of FIG. 7.

FIG. 9 is a partial, enlarged isometric view of the electronic cigarette and details of the RDA subassembly attached to the female tube.

FIG. 10 is a cut-away front isometric view of the electronic cigarette and RDA subassembly of FIG. 9.

FIG. 11 is cut-away side isometric view of the electronic cigarette and RDA subassembly of FIG. 9 taken 90 degrees from that direction shown in FIG. 10.

FIG. 12 is a side elevation view of the RDA subassembly.

FIG. 13 is a front elevation view of the RDA subassembly.

FIG. 14 is a top plan view of the RDA subassembly.

FIG. 15 is an isometric view of the RDA subassembly taken from an angle looking down on the RDA subassembly.

FIG. 16 is an exploded isometric view of the RDA subassembly.

FIG. 17 is yet another exploded isometric view of the RDA subassembly looking from a different angle.

FIG. 18A is a top plan view of the base member as part of the three-piece button assembly.

FIG. 18B is a side elevation view of the base member.

FIG. 18C is a sectional view of the base member taken along line 18C-18C of FIG. 18A.

FIG. 18D is an isometric view looking toward the top portion of the base member.

FIG. 18E is an isometric view of the base member looking downward at the threaded extension.

FIG. 19A is a top plan view of the intermediate ring member as part of the three-piece button assembly and having an oval configured slot.

FIG. 19B is a side elevation view of the intermediate ring member of FIG. 19A.

FIG. 19C is an isometric view of the intermediate ring member shown in FIG. 19A.

FIG. 19D is another plan view of the intermediate ring member shown in FIG. 19A.

FIG. 19E is an isometric view of the intermediate ring member having a slot configured as a moth.

FIG. 19F is a top plan view of the intermediate base member shown in FIG. 19E.

FIG. 20A is a front elevation view of the button screw member as part of the three-piece button assembly.

FIG. 20B is a top plan view of the button screw member.

FIGS. 20C and 20D are isometric views of the button screw member having a blank configuration.

FIGS. 20E and 20F are isometric views of the button screw member that cooperates with the intermediate ring member shown in FIGS. 19A through 19D.

FIG. 20G is a top plan view of the button screw member shown in FIGS. 20E and 20F.

FIG. 21 is an example of a traditional top cap personal vaporizer as an electronic cigarette.

FIG. 22 is an example of a hybrid top cap personal vaporizer as an electronic cigarette.

FIG. 23 is an isometric and partial schematic view of the electronic cigarette as a personal vaporizer similar to that shown in FIG. 5, but also showing the top cap covering the RDA assembly.

FIG. 24 is an enlarged view of the bottom end of the personal vaporizer of FIG. 23 showing in greater details the switch as a button assembly.

FIG. 25 is an end view of the firing pin.

FIG. 26 is an end view of the firing pin looking in the direction of 26 of FIG. 25 and showing the internal threads.

FIG. 27 is a front elevation view of an example of the male tube member having the switch as a button assembly.

FIG. 28 is a front elevation view of an example of the female tube member as a hybrid sleeve that could receive the male tube member.

FIG. 29 is an end view of an example of the button assembly having a three-piece button member in a butterfly configuration.

FIG. 30 is a front isometric view of a battery adapter that may fit within the housing formed by the male and female tube members to accommodate a battery of different size.

FIG. 31 is an exploded front elevation view of male and female tube members and having a different configuration of orifices on the female tube member as compared to the female tube member shown in FIG. 28.

FIG. 32 is an isometric end view of the button assembly showing the end of the firing pin.

FIG. 33 is a front elevation view of a “mod” device that includes the housing and button assembly and showing yet a different configuration of the openings and design on the female tube member.

FIG. 34 is another front elevation view of another “mod” device and showing yet another different ornamental configuration of the openings and design on the female tube member.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

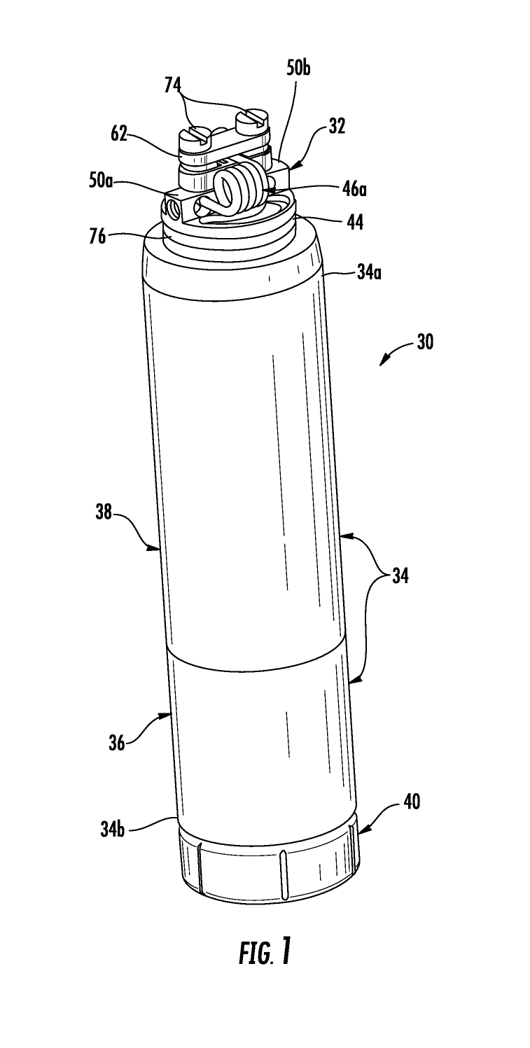

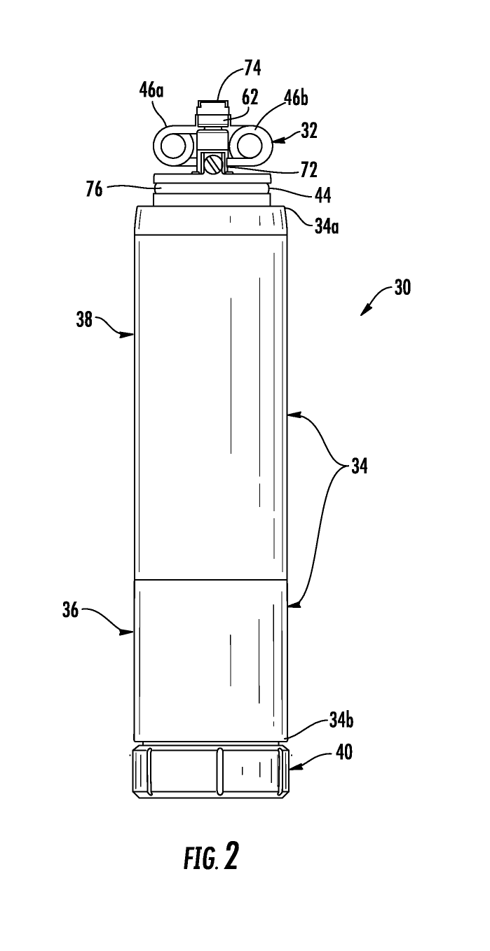

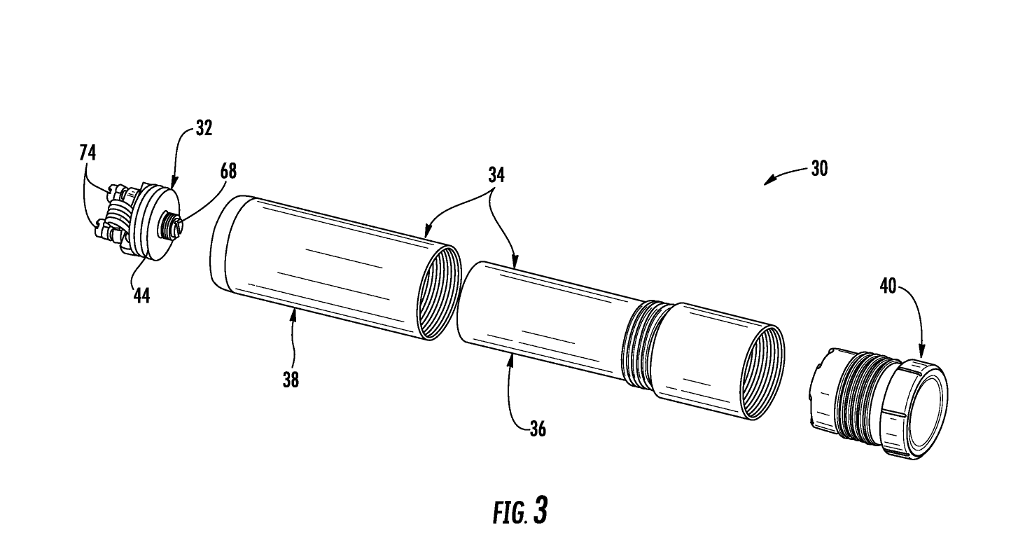

Referring now to FIGS. 1-4, there is illustrated the assembled electronic cigarette generally at 30 that includes three major subassemblies as the rebuildable dripping atomizer (RDA) subassembly shown generally at 32, a housing subassembly referred to also as the housing and generally indicated at 34 and formed from male and female tubes 36,38, and a bottom housing button subassembly indicated generally at 40, also referred to as the button assembly and operative as a switch such as by depressing a button. The button assembly 40 as a switch is a common component in many electronic cigarettes and completes the electrical circuit for operating the electronic cigarette and its functionality is explained in further detail below.

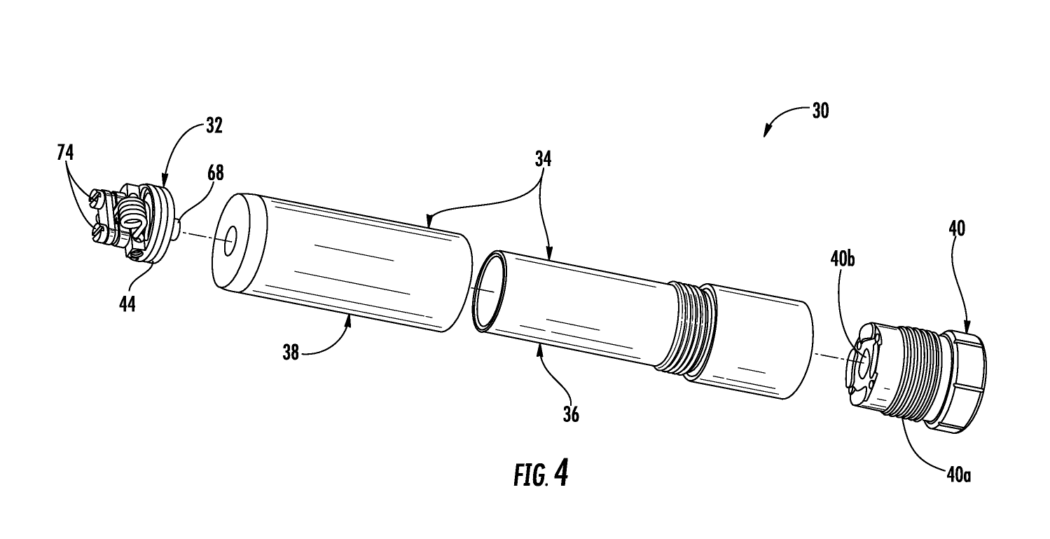

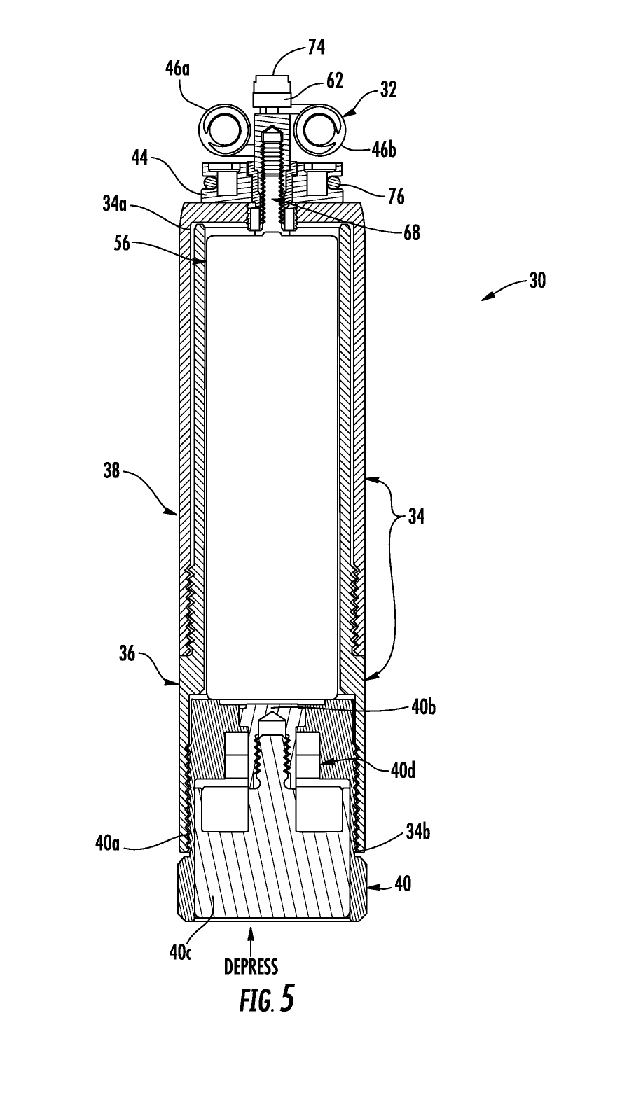

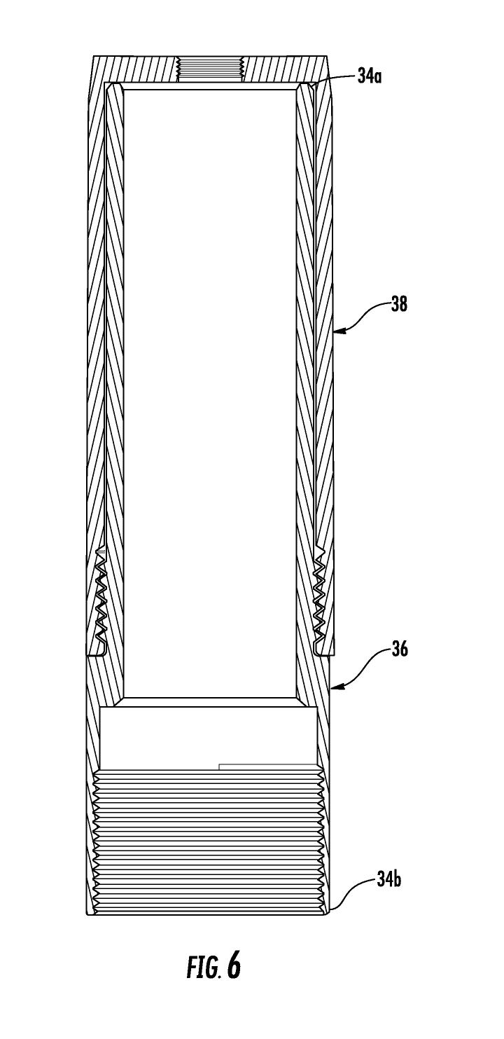

Referring also now to FIGS. 5-8 in addition to FIGS. 1-4, further details of the housing 34 and its construction are shown. As shown in FIG. 5, the housing 34 is cylindrically configured as a tube and formed of a conductive material such as brass, stainless steel, copper, or other metallic material, and has first and second ends 34a, 34b and configured to hold a battery having a positive pole adjacent the first end of the housing near the RDA subassembly 32 and a negative pole adjacent the second end of the housing where the button assembly 40 is located. In this embodiment, the housing 34 includes the male and female tubes 36, 38. In a unique design as an example, the female tube 38 has through-holes or orifices 42 (FIGS. 7 and 8) configured to expose portions of the male tube 36 so that ornamental effects located on the male tube can be seen through the orifices of the female tube. Also, the configuration of the holes may add to the ornamental appearance and have other functionality such as venting of any battery gas that may develop. Thus, a wide variety of ornamental features in the form of orifices or through-holes 42 (openings) may be added to the body of the female tube 38 to expose ornamental features on the male tube 36. The combination of features between the male and female tubes creates a secondary layer that is otherwise obscured. Additional ornamental features or colors may be added to provide a higher level of decorative aesthetic features.

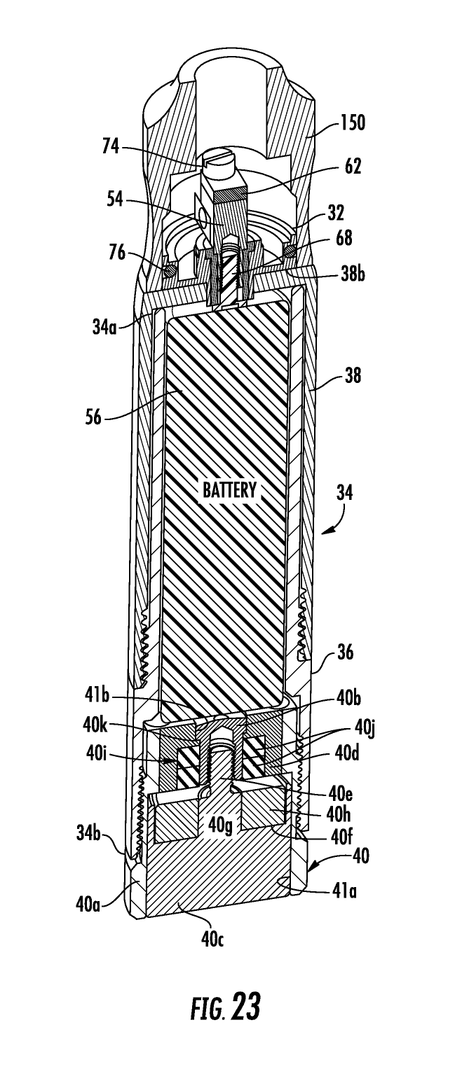

As illustrated, the button assembly 40 includes a threaded portion 40a (FIGS. 3, 4 and 5) as a button housing or switch housing that is received within a threaded portion of the male tube member and has an end with what some skilled in the art refer to as the first button or firing pin 40b or other button mechanism that is actuated when a button member 40c (FIG. 5) is depressed to complete the circuit in this example. This button assembly 40 in this example includes a solid piece that includes the button member 40c that may be pushed manually by depressing with a finger, such as the pinky. It may have two magnets that are polarized to each other and operates similar to a spring to move the firing pin as a contact mechanism to complete the electrical circuit and heat the heating coil. The magnets as a spring may be positioned in the area shown schematically in FIG. 5 at 40d, and explained in greater detail below with reference to FIG. 23 as a preferred three magnets, to illustrate this type of mechanism. However, in one example, the button 40c is depressed, which moves an extension as the “firing pin” 40b into the negative part of the battery in yet another example.

Referring now to FIGS. 9-17, the RDA subassembly 32 includes a cylindrically configured RDA deck 44 formed from a conductive material such as stainless steel, brass, copper, or other metallic material, and supported at the first end 34a of the housing 34 and configured to support first and second heating coils 45a, 46b, each being a single large filament as a heating coil or a number of individual filaments wound together. The heating coils 46a, 46b are best shown in FIGS. 13-17. The RDA deck 44 includes a central orifice 48 and first and second spaced terminal posts 50a, 50b configured to connect to first ends of respective first and second heating coils 46a, 46b using a mechanical attachment mechanism as explained below. A central column terminal 52, also referred to as a T-column, includes a central post 54 received within the central orifice 48 of the RDA deck 44 that engages the positive pole of a battery 56 held within the housing 34 and a transverse support 58 formed as an upper “T” of the “T-column” carried by the central post 54 and spaced above the terminal posts 50a, 50b and on which second ends of respective first and second heating coils 46a, 46b are positioned such as best shown in FIG. 12 where the ends are positioned on a compression slot 60 formed thereon.

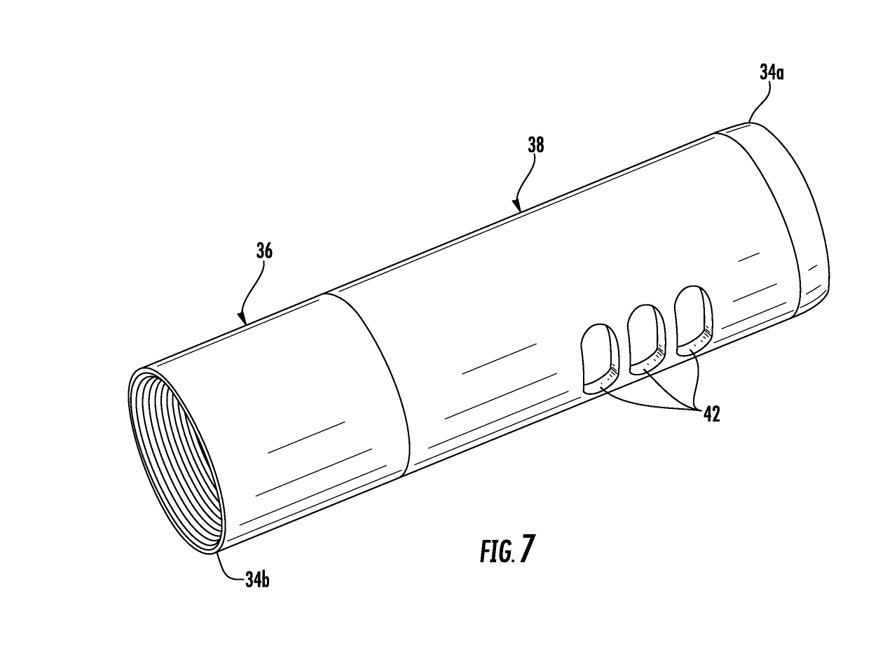

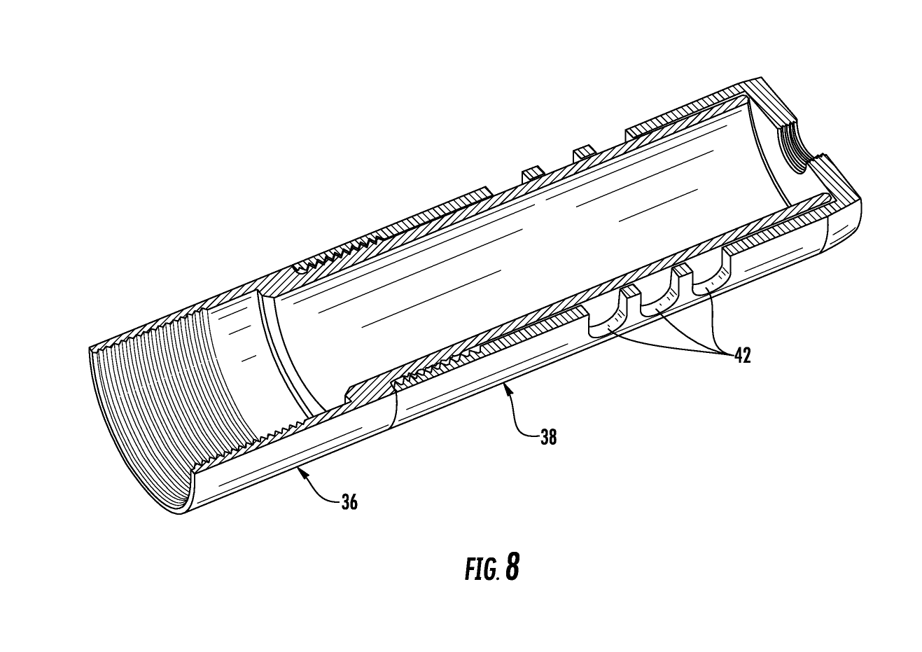

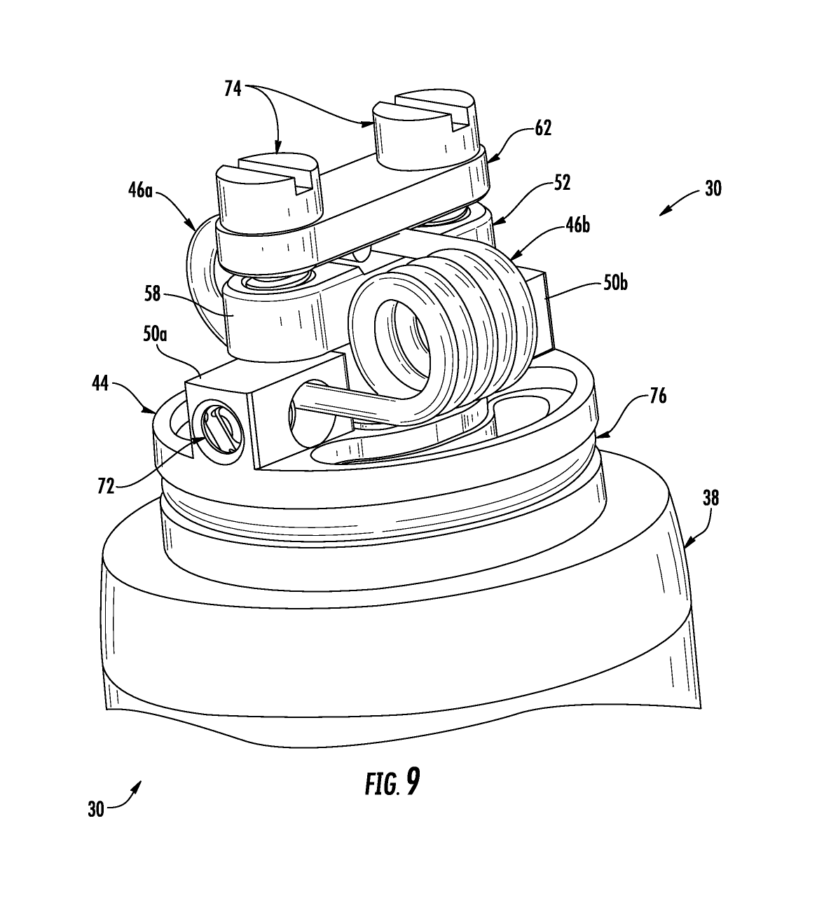

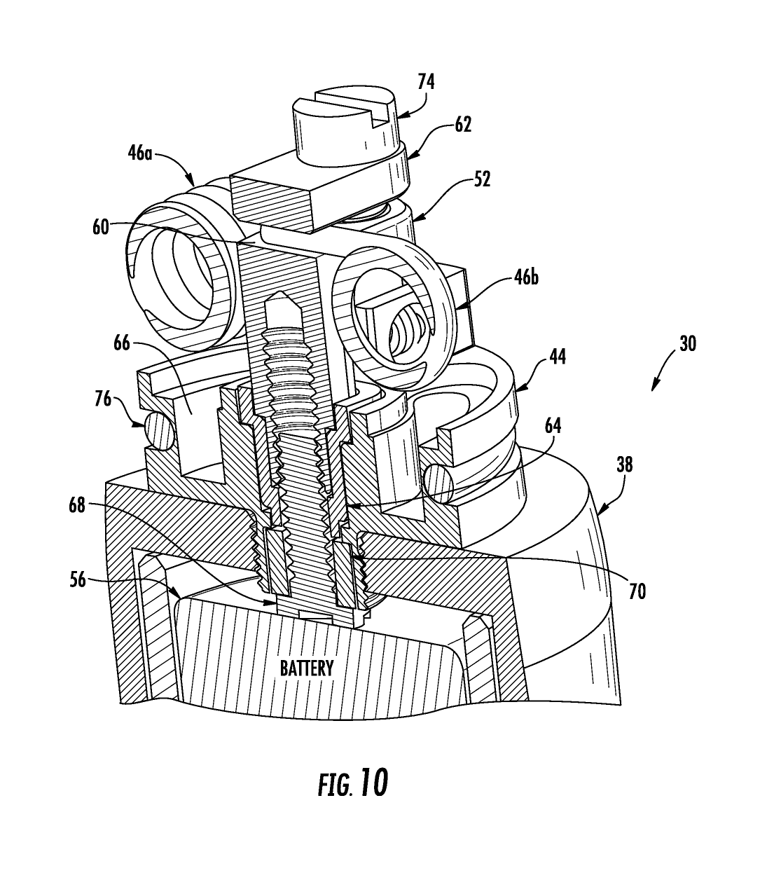

A clamp bar 62 is secured onto the transverse support 58 and fixes the second ends of the heating coils 46a, 46b on the transverse support 58. An insulator 64 in one example is formed as a sleeve (FIG. 10) and is received within the central orifice 48 of the RDA deck 44 and receives the central post 54 and separates and electrically insulates the central post 54 from the RDA deck 44. It is formed from a plastic or other insulator material. As shown in FIGS. 9 and 10, the RDA deck 44 includes a cylindrically configured and recessed well 66 below the terminal posts 50a, 50b to hold the juice used for vaping, for example. The terminal posts 50a, 50b are formed on the upper circumferential edge of the RDA deck (FIG. 9) so that the well 66 has a large annular configuration that is deep, and in an example, has an internal stepped configuration as shown in FIG. 10.

The button assembly 40 operates as a switch, and as noted before, is located at the second end 34b of the housing, and when closed, the switch completes an electrical circuit from the negative pole of the battery 56 at the second end 34b of the housing and through the housing 34 to the RDA deck 44 and energizes the heating coils 46a, 46b to vaporize the juice contained on at least one wick, and in the illustrated example, the wicks held by the heating coils. The central post 54 includes a contact screw 68 that engages the battery 56, such as the positive terminal at the top of the battery, and is adjustable relative to the battery to ensure electrical contact when the switch is closed. A sleeve ring 70 formed from an insulator material such as plastic encompasses the contact screw 68 to separate and electrically insulate the contact screw from the RDA deck 44. Set screws 72 may secure the first ends of the heating coils 46a, 46b onto the respective terminal posts 50a, 50b and clamp screws 74 may secure the clamp bar 62 to the transverse support 58.

The RDA deck 44 includes an annular outer surface and supports at least one O-ring 76 on the outer surface to retain an RDA cap and a drip tip in an example (not shown) that are received over the RDA deck. The transverse support 58 includes the compression slot 60 as best shown in FIGS. 9, 11, and 16 into which the second ends of the heating coils 46a, 46b are received to aid in securing the second ends of the respective first and second heating coils. The heating coils 46a, 46b are also sometimes referred to as wire filaments by some skilled in the art since the heating coils are small gauge wires. The heating coil may also be formed from a plurality of wire filaments that are wound together. Typically, a heating coil is one gauge and a small diameter of wire or filament that is formed of a material having properties that allow it to heat and vaporize the juice when a current flows through the wire.

The RDA deck 44 is formed from an electrically conductive material such as brass, stainless steel, copper, or other metallic material, and stores a prescribed amount of juice or e-juice as it is sometimes referred as the liquid in the recessed well 66. The RDA deck 44 operates as a base upon which other components of the RDA subassembly 32 attach through various mechanical fastening techniques such as the described set screws 72 and clamp screws 74. The lower portion of the RDA deck 44 includes a mechanical attachment to the female tube 38, the preferred embodiment of which is a male threaded fastener that mates with a female threaded orifice on the top portion or first end 34a of the female tube 38 of the housing 34 so that the RDA deck is secured to the housing via the threaded engagement, thereby creating an electrical connection between the RDA deck 44 and the female tube 38 and the overall housing. The RDA deck 44 includes the recessed well 66 as described before that is of a depth sufficient to retain a volume of fluid as the juice for “vaping.” The recessed well 66 in one example is annular configured within the RDA deck 44 and positioned below the terminal posts 50a, 50b and may be of any singular profile or stepped profile as best shown in FIG. 10 where the various shoulder portions forming the stepped profile are configured to any desired depth within the body member forming the RDA deck 44. This profile helps retain the juice and wicking of juice on the wicks. As also shown in the various drawings, the RDA deck 44 may include one or a plurality of recesses or grooves on the outer peripheral surface, such as the illustrated groove formed around the perimeter or outer surface, to receive and retain one or more O-rings 76 that help retain the RDA cap.

In another embodiment, two or more grooves or other receiving recesses in the RDA deck 44 would receive a plurality of O-rings and retain a RDA cap and sometimes drip tip (not shown) over the RDA deck 44 as known to those skilled in the art. The RDA deck 44 includes in this example the electrical terminal posts 50a, 50b formed above the recessed well 66, on an upper annular top surface or edge surface forming the RDA deck. The two opposing electrical terminal posts 50a, 50b are of a negative polarity and positioned in-line with the central column terminal 52 as the configured T-column and the clamp bar 62 to connect to first ends of respective first and second heating coils 46a, 46b, which could be formed in an example as a number of filaments or a preferred single gauge wire that has sufficient resistance for heating and vaporizing the juice when the electrical circuit is closed.

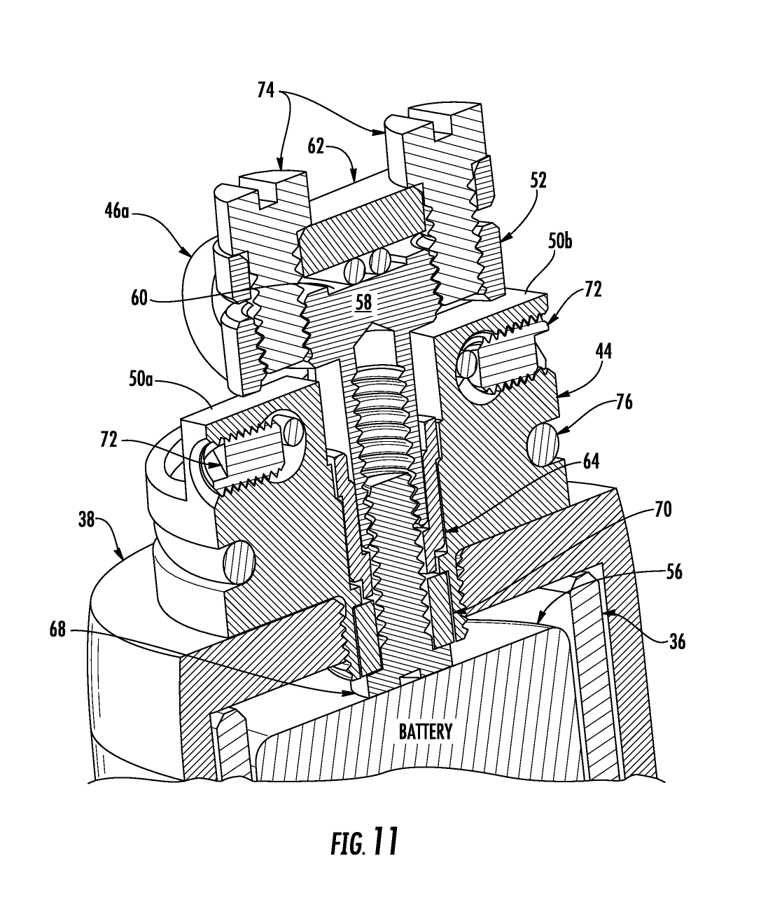

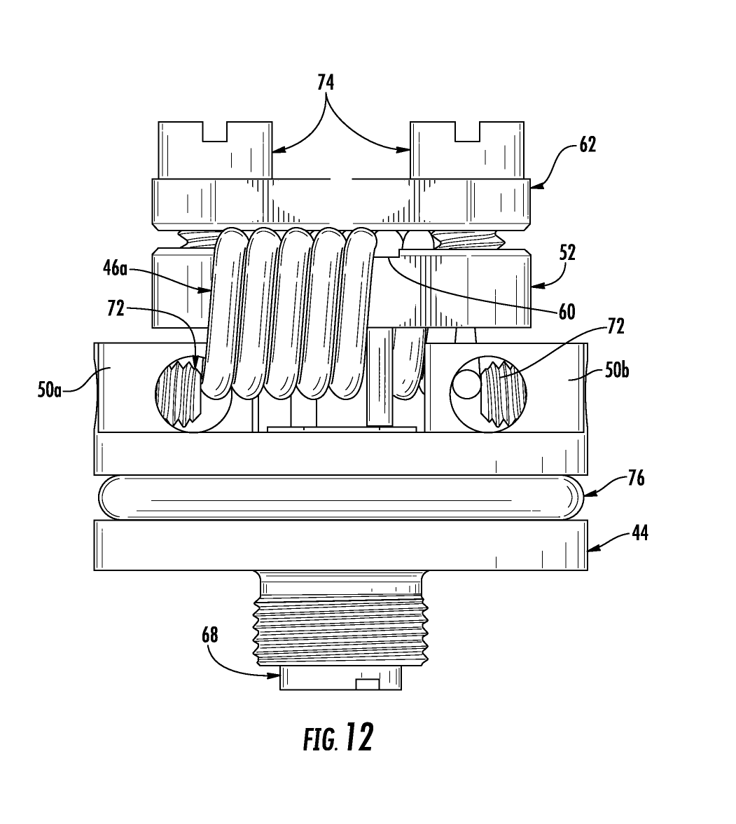

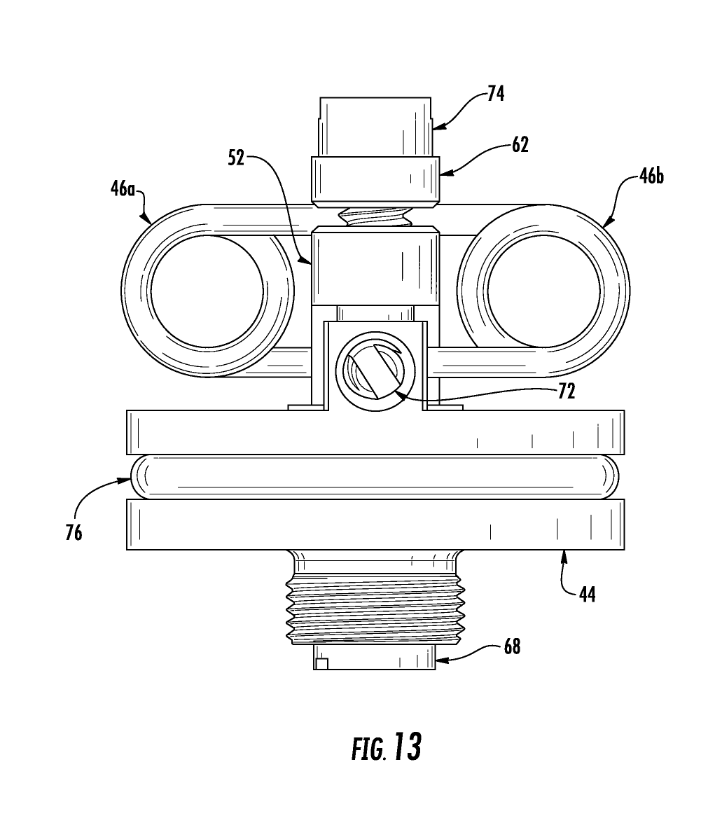

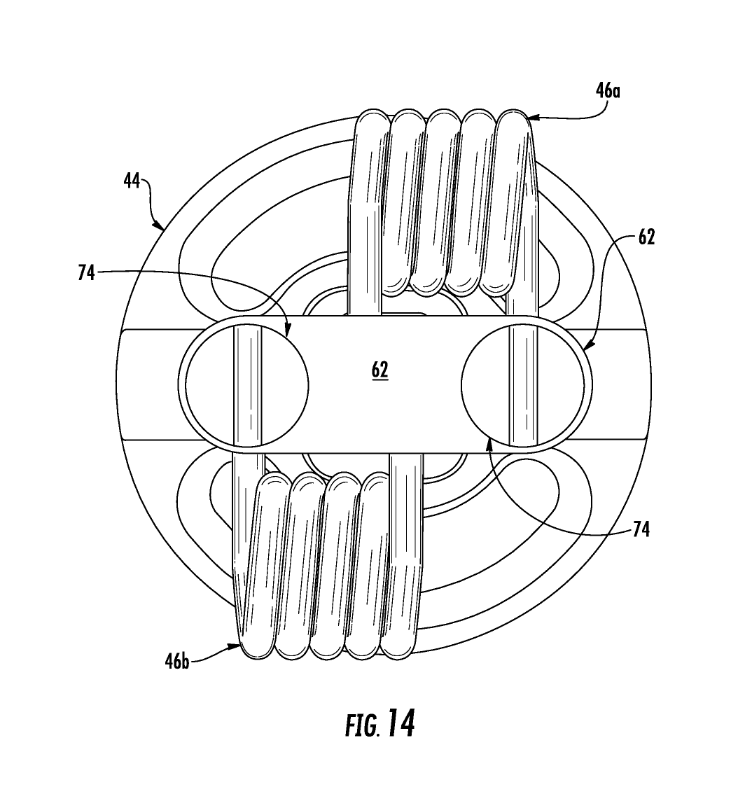

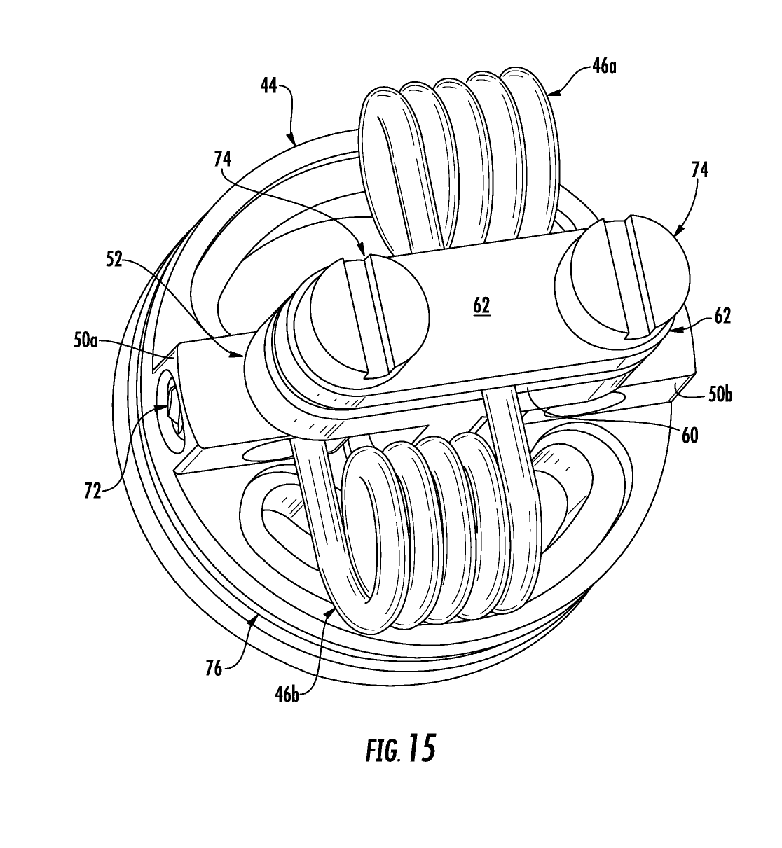

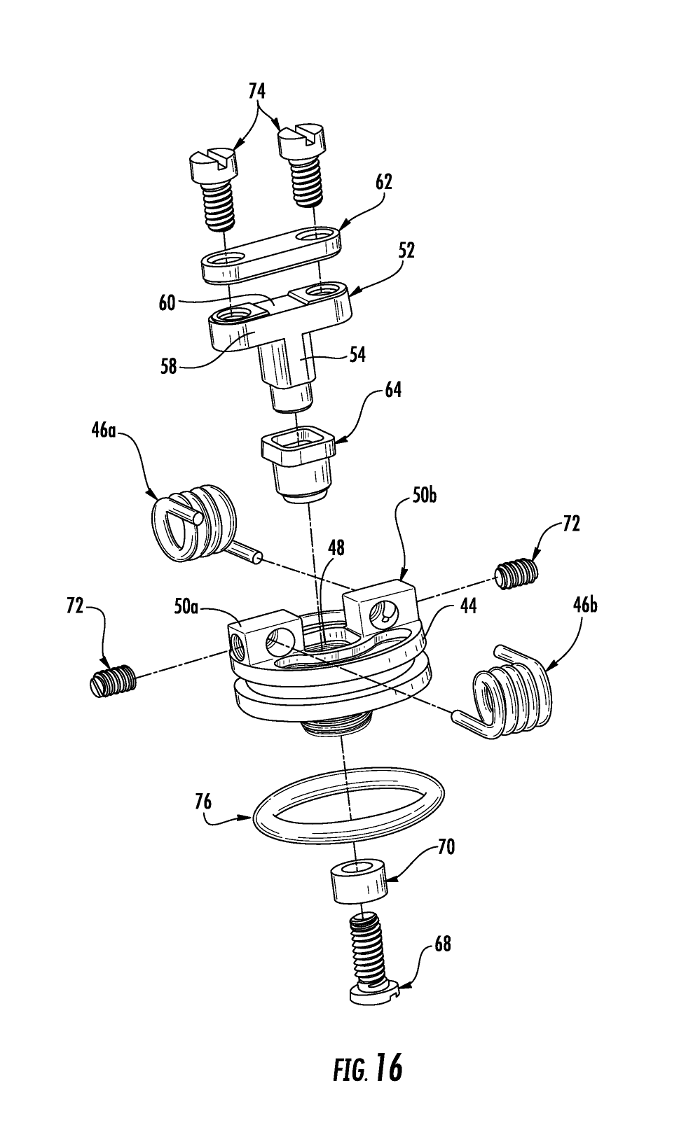

The first and second terminal posts 50a, 50b may each include a primary smooth bore as a through-hole through which a free end of one or more wire filaments or heating coils 46a, 46b may be inserted and passed through as illustrated in the drawings. A secondary blind hole as a preferred female threaded fastener blind hole intersects the through-hole that had received the heating coil, and in turn, receives the set screw 72. This blind hole may be oriented at an angle relative to the primary smooth bore as the through-hole that receives the heating coil such that the set screw 72 is screwed in as a mechanical attachment and creates a compressive force upon the free end of the wire filaments or heating coil against the respective terminal post 50a, 50b, thereby creating an electrical connection between the RDA deck 44 and the one or more wire filaments or heating coil. The RDA deck 44 includes the central orifice 48 as a through-hole of varying cross-sections through which the central post 54 of the central column terminal 52 as the T-column is received. It also receives the sleeve 64, the sleeve ring 70, and contact screw 68 that are assembled together (FIGS. 16 and 17). The central orifice 48 as a through-hole of the RDA deck 44 preferably includes a plurality of stepped shoulders (shown in FIGS. 10 and 11) forming a stepped configuration upon which the compressive forces imposed by the mechanical arrangement of the sleeve 64, sleeve ring 70, central post 54 of the central column terminal 52 and contact screw 68 may be applied to aid in retaining those components together.

The at least one O-ring 76 may be formed from an easily compressible and elastic material and serve to create an air-tight seal between the RDA cap and drip tip (not shown) that are commonly used in the art and operate as an assembly technique between the RDA deck 44 and the common RDA cap via a compression fit interaction. The at least one O-ring 76 is received along the groove or other recess that extends along the outer peripheral surface of the RDA deck 44 and is held in place by the contours of the groove and the tensile elastic deformation of the O-ring.

The sleeve 64 is an insulator as described above is formed from an electrically insulating material and could be formed from one or more components. It serves as an electrical insulator to ensure no physical contact is made between the central column terminal 52 and the contact screw 68 and the RDA deck 44. In one example, it encompasses all or portions of the central post 54 and portions of the contact screw 68 that would otherwise make physical and electrical contact with the RDA deck. The bottom of the sleeve 64 on both the inside and on its orifice may include a shoulder or other stepped portion forming a profile to engage a stepped portion of the RDA deck central orifice 48 and a stepped portion of the central post as best shown in FIGS. 10 and 11. The sleeve 64 is inserted through the through-hole, i.e., central orifice 48 of the RDA deck from above. The sleeve 64 includes a through-hole of varying cross-sections through which the central post 54 and contact screw 68 are inserted and assembled via a mechanical technique. The sleeve 64 as noted before includes a plurality of shoulders or other stepped profile features both internally and externally upon which the compressive forces of the mechanical assembly of the RDA deck 44, sleeve ring 70, central column terminal 52, and contact screw 68 are applied.

The sleeve ring 70 could be formed from one or more components and is formed from an electrically insulating material. The sleeve ring 70 serves as an electrical insulator to ensure no physical contact is made between the contact screw 68 and components of the RDA deck 44 by encompassing all or portions of the contact screw 68. The sleeve ring 70 is inserted through the through-hole as the central orifice 48 of the RDA deck 44 from below. The sleeve ring 70 may include a through-hole of varying cross-section through which the contact screw 68 is inserted and assembled by mechanical fasteners to the central post 54, the RDA deck 44, and sleeve 64. In one example, the sleeve 64 may include a plurality of shoulder features having a stepped configuration, internally and externally, upon which the compressive forces of the mechanical assembly of the RDA deck 44, sleeve 64, central column terminal 52, and contact screw 68 apply.

The contact screw 68 (also termed by some as a 510 pin) is also made from an electrically conductive material and could be formed by one or more components along with the other conductive components, to transmit electrical energy from the battery terminal as the positive terminal in this case to the heating coils 46a, 46b. The contact screw 68 is inserted into the through-hole of the sleeve ring 70 and the combination of the two then inserted into the through-hole as the central orifice 48 of the RDA deck 44 from below and then further assembled by mechanical attachment to the central post 54 and sleeve 64. The contact screw 68 serves as one of the two electrical contacts for the battery 56 and maintains a constant electrical connection with the battery when the apparatus as the electronic cigarette is fully assembled.

The clamp screws 74 are also made from an electrically conductive material to affix the clamp bar 62 to the transverse support 58 as the top “T” of the central column terminal 52, also termed the T-column, via a mechanical attachment using the clamp screws 74 in a preferred embodiment, which simultaneously apply compressive forces between the clamp bar and the central column terminal such that force is applied to the free second ends of the heating coils 46a, 46b, thereby retaining and affixing free ends of the wire filament or heating coil in place. This creates an electrical connection between the central column terminal 52 and clamp bar 62 and heating coils 46a, 46b. The clamp bar 62 is one component in a series of components used to transmit electrical energy from the battery terminal to the wire filaments or heating coil.

The central column terminal 52 that is also referred to as the T-column is formed from a conductive material such as stainless steel, brass, copper, or other metallic or conductive material, and used as an intermediary component to transmit the electrical energy of the battery to the heating coils 46a, 46b while insulated against electrical contact with the RDA deck 44 via the sleeve 64. The central post 54 of the central column terminal 52 or “T-terminal” is inserted into the sleeve 64 to separate and electrically insulate the central column terminal as the T-column and the RDA deck 44. It is affixed to the RDA deck 44 via mechanical attachment of the contact screw 68 that creates compressive forces on the shoulders formed on the RDA deck, sleeve and sleeve ring as best shown in FIGS. 10 and 11. By using the mechanical attachment as described above for the contact screw 68 and central column terminal 52, an electrical connection is made between the battery terminal, contact screw 68, and central column terminal 52.

Additionally, by using the compressive forces that are exerted against the clamp bar 62 via the clamp screws 74 as a mechanical attachment to the central column terminal 52 as the T-column to retain and affix one of the free ends of the wire filaments or heating coil, an electrical connection is thus created between the central column terminal and clamp bar and the heating coils 46a, 46b.

The heating coils 46a, 46b may be formed from multiple strands of wire filaments or one wire as a single gauge forming a heating coil as a single strand, and of course, from an electrically conductive material that has the properties and resistance to heat up when the switch is closed and atomize fluid on a wick. The physical connection is made at either free end to create an electrical connection where the electrical energy is passed through the heating coils upon activation of the device as an electronic cigarette by the user. This can occur in one example by depressing their pinky finger against the lower end of the switch 40 as a button assembly and on the button member 40c (button) that in an example is positioned at the second end of the housing and explained above. In some embodiments, the switch may be attached onto the housing itself at the peripheral side along the cylindrical surface and actuated by the thumb. The natural electrical resistance of the wire filament as a heating coil, in an example, generates heat sufficient to vaporize a prescribed liquid substance such as the juice contained on a wick, in one example, and contained in the recessed well 66. Different flavors of juice may be used and different types of juice. The heating coils 46a, 46b have one free end affixed to the RDA deck 44 via its electrical terminal posts 50a, 50b and the mechanical attachment via the set screws 72. The opposing free end is affixed to the transverse support 58 of the central column terminal as the T-column and by the clamp bar via the assembled compressive forces.

The set screws 72 may be made of an electrically conductive material and aid in creating an electrical connection between the free end of the heating coils 46a, 46b and the electrical terminal posts of the RDA deck. This is accomplished by passing the free end of the heating coils 46a, 46b through or within the through-hole of the electrical terminal first and second posts 50a, 50b and using a mechanical attachment via the set screws into the electrical terminal post blind holes, which intersect the through-holes, to compress, retain and affix the free ends of the heating coils.

The battery 56 serves as a source of stored electrical energy to power the device as the electronic cigarette 30. The battery 56 can be any form that can be held within the cylindrical housing 34 formed from the female tube 38 and male tube 36.

The male-female tube subassembly forming the housing 34 includes the female tube 38, which is made from an electrically conductive material as noted before and uses a housing or storage as the male tube for the battery 56 as shown in FIG. 5 and as an intermediate component to transfer the electrical energy of the battery from one terminal of the battery to the switch 40 or button assembly forming the bottom housing button subassembly and through the male and female tubes 36, 38 to the RDA subassembly 32 where it ultimately flows back to the opposing terminal of the battery. The female tube 38 uses mechanical attachment techniques to attach to the RDA deck 44 of the RDA subassembly 32, the preferred embodiment of which is a female threaded fastener. The female tube may have the plurality of through-holes 42 on any portion of its length of any size or shape that can be configured to give a unique design and permit the otherwise obscured portion of the male tube to be seen and give a further decorative ornamental effect by allowing the surface of the male tube to be exposed.

The male tube 36 is also made from an electrically conductive material and used as a housing for the battery and as an intermediate component to transfer the electrical energy of the battery from one terminal of the battery to the switch 40 as the button assembly and to the female and male tubes to the RDA subassembly 32 where the current flows back to the opposing terminal of the battery 56. The male tube 36 uses a mechanical attachment as threads in this example to attach the button assembly 40 to its lower end, the preferred embodiment which is a female threaded fastener shown in FIGS. 1-4. The male tube 36 mechanically attaches to the female tube 38, the preferred embodiment of which is a male threaded fastener. The male tube 36 inserts within the volume of the female tube 38 as best shown in FIG. 5, which partially or wholly obscures a portion of the male tube's length, depending on the geometry of the female tube.

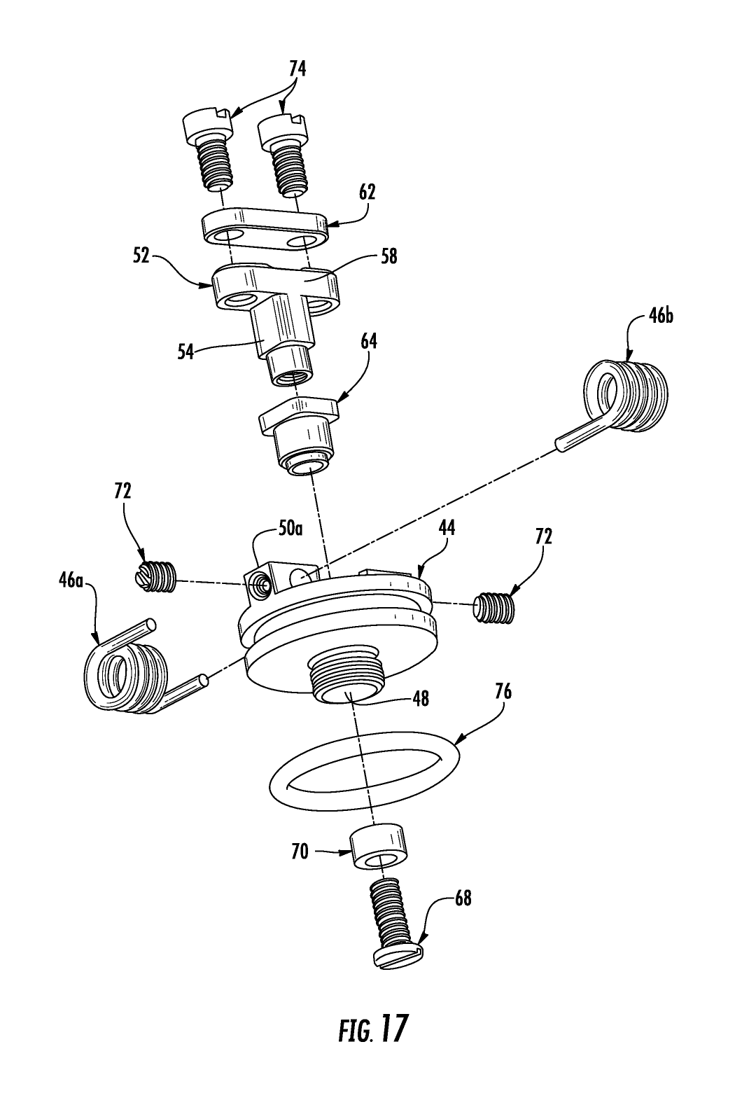

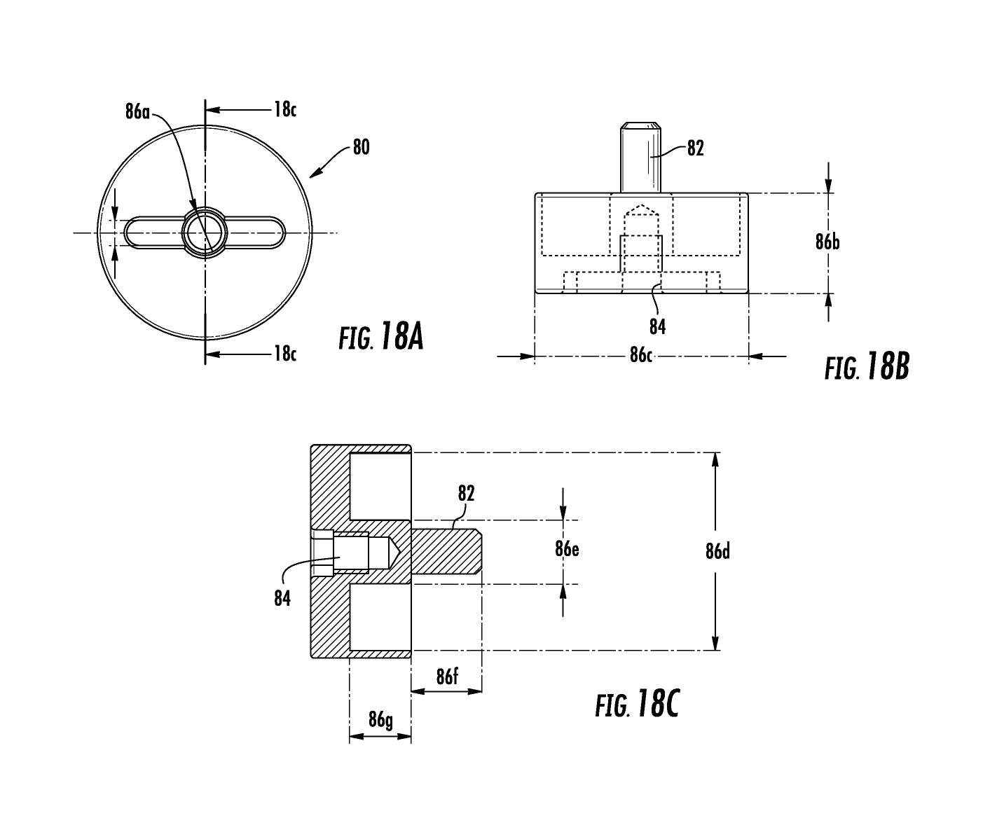

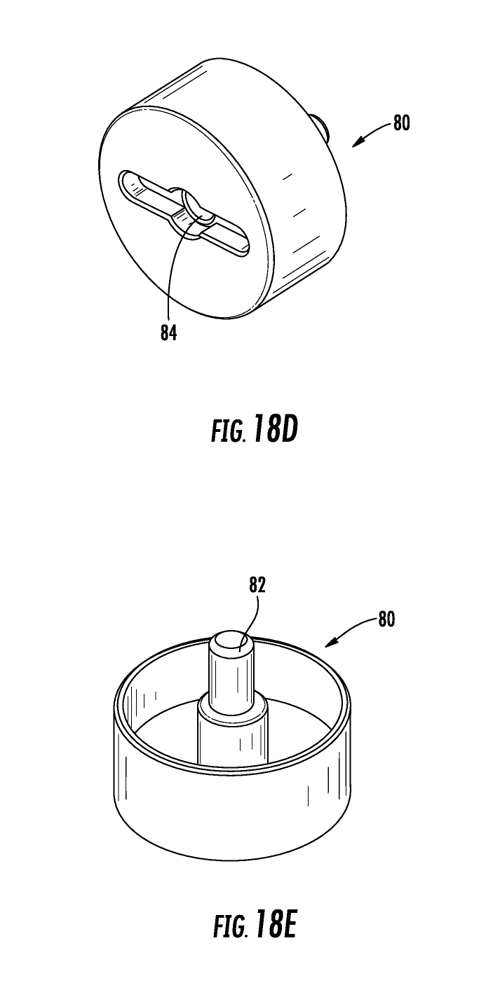

The button assembly 40, also referred to as the bottom housing button subassembly, operates as a switch sufficient to open and close an electrical circuit, acting as a normally open electrical switch between the positive terminal of the battery 56 and its opposing negative terminal as explained above. The button assembly 40 mechanically attaches by threading into the male tube 36 and an electrical connection is created that allows electrical energy of the battery 56 to flow through the tube and establish an electrical circuit. The user of the electronic cigarette as the apparatus may depress using their finger, such as their pinky, the button member or button 40c of the button assembly 40 to selectively open or close the electrical switch, thereby activating or deactivating the apparatus as the electronic cigarette. A standard design as a one-piece button is illustrated, such as in FIG. 5, and includes a pin or firing pin mechanism, but could be a three-piece button assembly, such as shown and explained below with reference to FIGS. 18A through 20G.

One advantage of positioning the terminal posts 50a, 50b in line with the central column terminal 52 and clamp bar 62 is that it creates an arrangement where one free end of the heating coils 46a, 46b may be inserted into either of the electrical terminal posts, at the discretion of the user, and the opposing free end of the heating coils may be simultaneously inserted into the compression slot 60 formed on the top of the transverse support 58, thereby reducing the difficulty of assembly. Another advantage of this preferred embodiment's arrangement is that all of the electrical connection features are positioned above the recessed well 66, thereby maximizing the available volume of fluid storage within the recessed well.

An advantage of having the male tube 36 inserted within the female tube 38 is that a wide variety of ornamental features in the form of through-holes can be added to the body of the female tube, which then will expose the male tube's otherwise obscured portions for ornamental or decorative effects. This combination of the features between the male and female tubes 36,38 creates a secondary layer for the otherwise obscured portions of the male tube, upon which ornamental features or colors may be added to provide a higher level of decorative aesthetic when compared to other devices.

In an example, the RDA deck 44 may be 22 mm and include 2.5 mm post holes to fit all popular gauges of wire. It can include titanium screws and has an easy building area. The terminal posts can be milled to the deck to cut down on spinning or breaking. The positive center has a keyed bottom to prevent spinning. The titanium screws add to an aesthetic appeal. A battery may be added to the housing by unscrewing the button housing 40 and inserting a battery. An example could be a high drain 40 amp battery with the positive end in first. The firing pin or button 40b may be adjustable such as formed as a screw.

Different types of heating coils “vape wires” may be used, including Kanthal (FeCrAl), Nichrome, stainless steel, nickel, and titanium. Stainless steel is considered by many to be the most versatile. Different grades of stainless steel wire may be used. The most popular gauges for the wire are 32, 30, 28, 26, 24, and 22. The type of wicking material can vary and could include organic cotton, Japanese cotton pads, ekowool, silica, and rayon fiber.

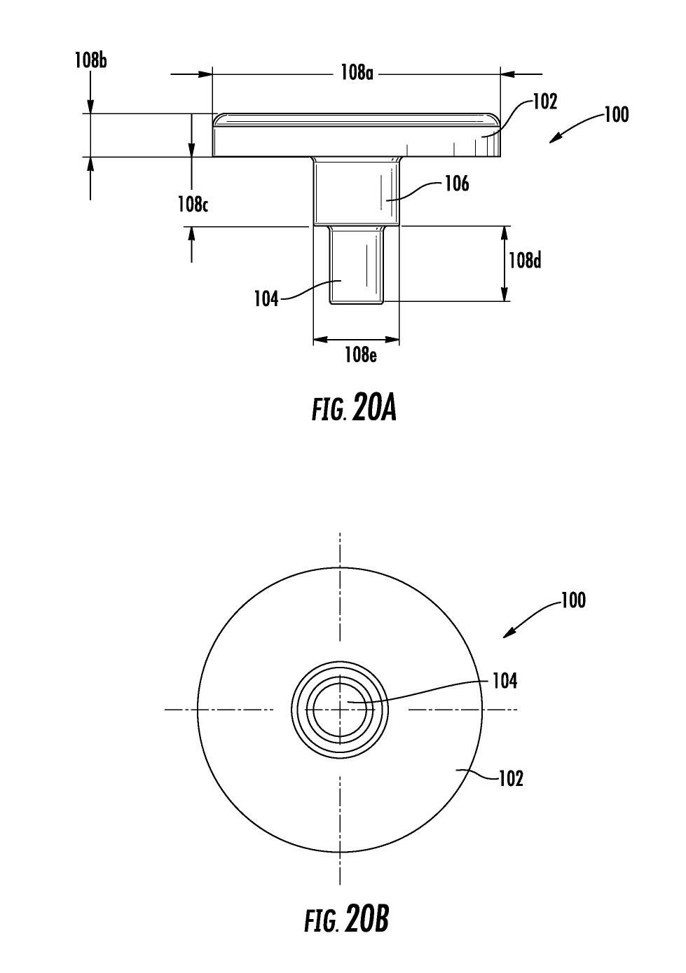

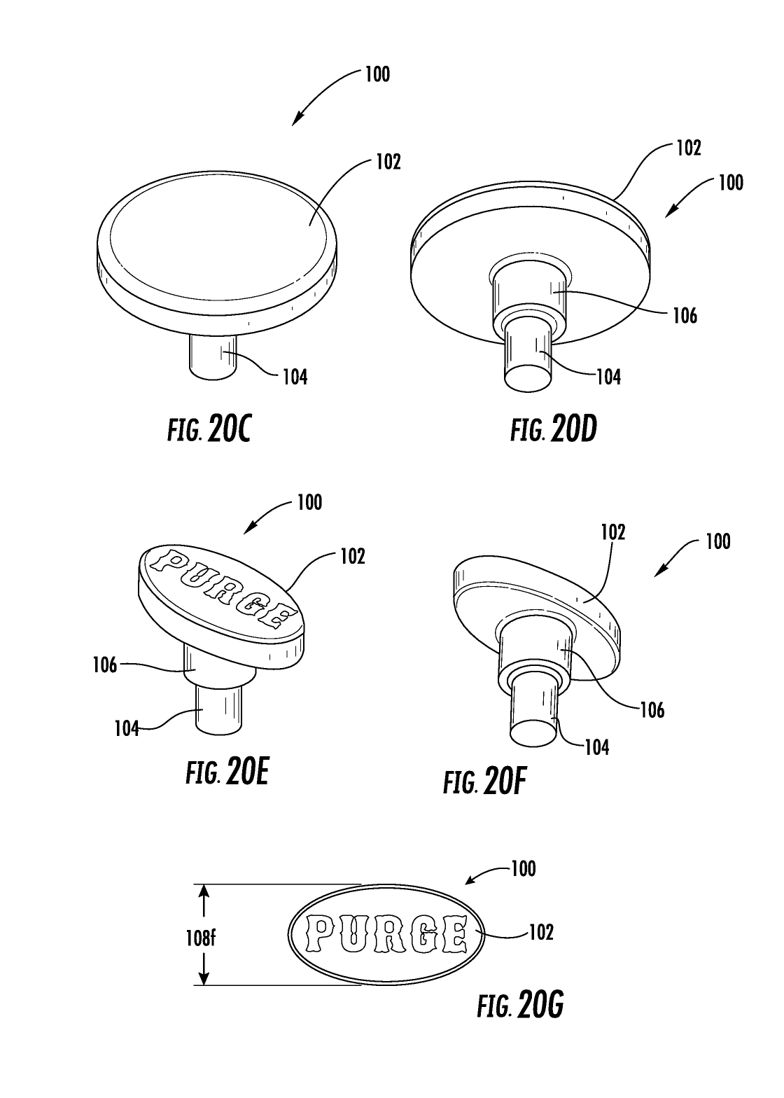

As noted before, FIGS. 18A through 20G illustrate components of a three-piece button assembly that could operate with the firing pin mechanism as described above. FIGS. 18A through 18E show the base member 80 of the three-piece button assembly where the base member has a threaded extension 82 adapted to cooperate with a firing pin 40b mechanism, and it includes a threaded orifice 84. Dimensions of various parts can vary, but in an example, the thread depth shown in FIG. 18A and indicated generally at 86a may have a M4×0.7 and 0.220 inch minimum thread depth. The threaded extension 82 or shaft that cooperates with the firing pin mechanism in an example may have a M4×0.7 thread and it should be test fit with the firing pin before it is fully bottomed out. The dimension 86b (FIG. 18B) for the height of the base member could be about 0.384 inches and with an option 1 such as use with the button screw member shown in FIGS. 20C and 20D could be about 0.399 inches. The diameter as shown by dimension 86c could be about 0.823 inches. In the sectional view shown in FIG. 18C, the dimension could be about 0.764 inches 86d, and dimension 86e could be about 0.244 inches. The thread extension as dimension 86f could be about 0.276 inches, and dimension 86g could be about 0.240 inches. The isometric view shown in FIGS. 18D and 18E show a configuration for the base member. When it is test fit with the button screw member, it must fully bottom out.

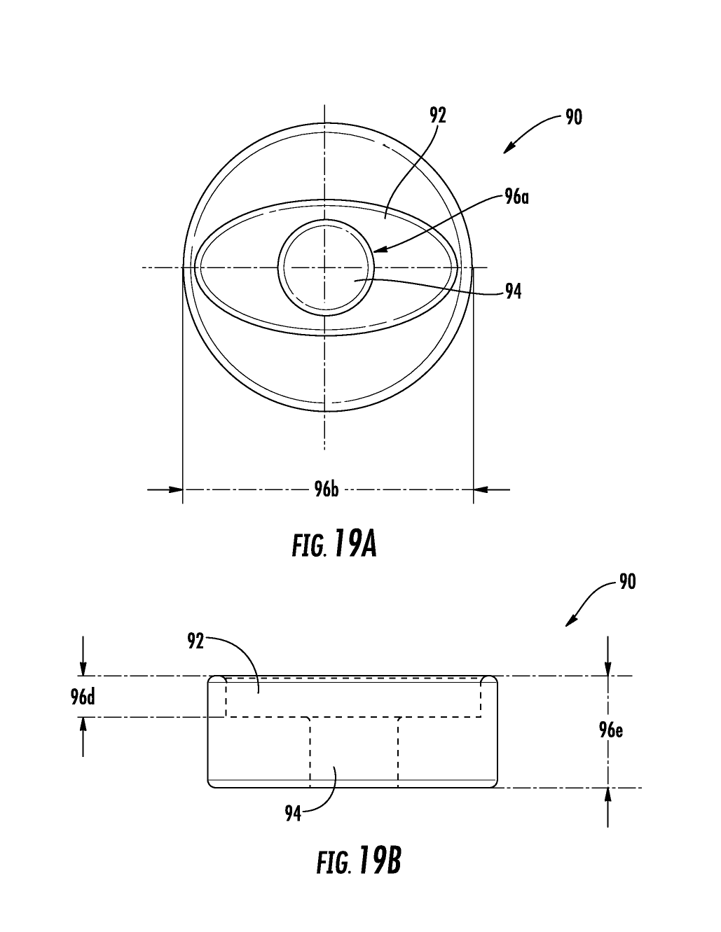

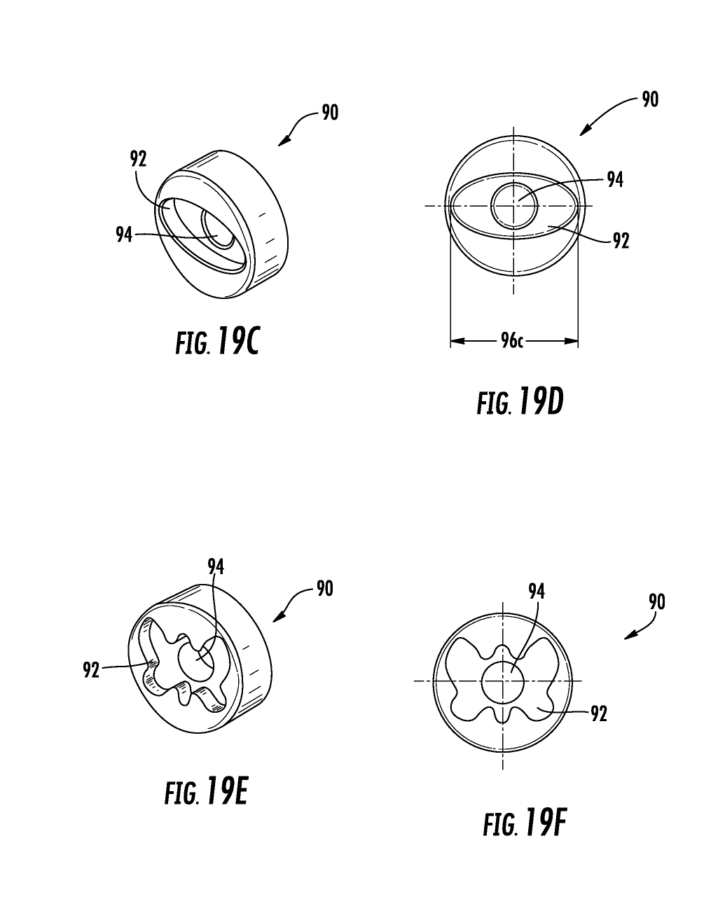

Referring now to FIGS. 19A through 19F, there is illustrated the intermediate ring member 90 that is interposed between the base member 80 and a button screw member 100 shown in FIGS. 20A through 20G. The ring member includes a slot 92 extending partially through the intermediate ring member and followed by through-hole 94. The slot 92 has a configuration to match and receive the head 102 of the button screw member 100. Representative dimensions such as 96a for the diameter could be about 0.250 inches, and dimension 96b as a diameter of about 0.820 inches.

FIGS. 19C and 19D show the oval configuration such as shown in FIGS. 19A and 19B, where the slot is oval and has a length of about 0.725 inches as dimension 96c. In FIG. 19B, the depth of the slot may be about 0.120 inches (96d) and the height of the intermediate ring member could be about 0.320 inches (96e). A configuration showing a moth configured slot for the intermediate ring member is shown in FIGS. 19E and 19F.

Referring now to FIGS. 20A through 20G, there is shown an embodiment of the button screw member 100 that includes the head 102 having a predetermined configuration such as the oval shown in FIGS. 20E, 20F, and 20G, and a threaded shaft 104 extending therefrom and supported on a central hub support 106. The threaded shaft 104 is received into the threaded orifice 84 in the base member 80. The threaded shaft 104 or extension as it may be called may include an M4×0.7 thread with dimensions varying such as at 108a as 0.822 inches in diameter, 108b as 0.125 inches, 108c as 0.200 inches, 108d as 0.225 inches, and 108e as 0.245 inches. The head 102 may include engravings such as shown in FIG. 20E and have a polished metal finish and have a dimension of about 0.365 inches (108f).

In an example, the base member and button screw member are formed of a metallic material that could be as an example stainless steel, brass, or copper. The intermediate ring member could be formed from a plastic material and may have decorative features. In an example, plastic materials could include polyetherimide as an amber-to-transparent solid often used with 3D printers and also referred to by the tradename Ultem and have heat resistance, solvent resistance and flame resistance, and a high dielectric strength. Another material could be Delrin as polyoxymethylene also referred to as Celcon and by other tradenames. It has high strength, hardness and rigidity, and is available in different colors. Acrylic could be used. Many other plastics could be used. For all components, normal manufacturing tolerances typically may apply.

The electronic cigarette 30 as described above may also be described as a personal vaporizer that operates an inhaler for “vaping” and of course, for personal use. It uses the described RDA subassembly 32, which is connected by a threaded connection in a central threaded orifice 38a onto the female tube 38, also described as a female tube member, which operates as a sleeve to receive the male tube 36, also referred to as the male tube member. The term “member” can be used with and without the term male tube or female tube. The male and female tube members are typically formed of a metallic material, but could be metal plated plastic in an embodiment. The metallic material could be copper, brass, aluminum, or other materials. The female tube member 38 can be referred to as a hybrid sleeve, since the female portion will accept the RDA subassembly, such as via a commonly referred to 510 connection, and thus, the top cap with the hybrid sleeve as the female tube member is combined with the male tube member, which is received within the female tube member operating similar to a sleeve. It should be understood that different rebuildable atomizers (RBA's) may be supported by and connected to the female tube member and a preferred RDA is described above, rebuildable tank atomizers may be attached.

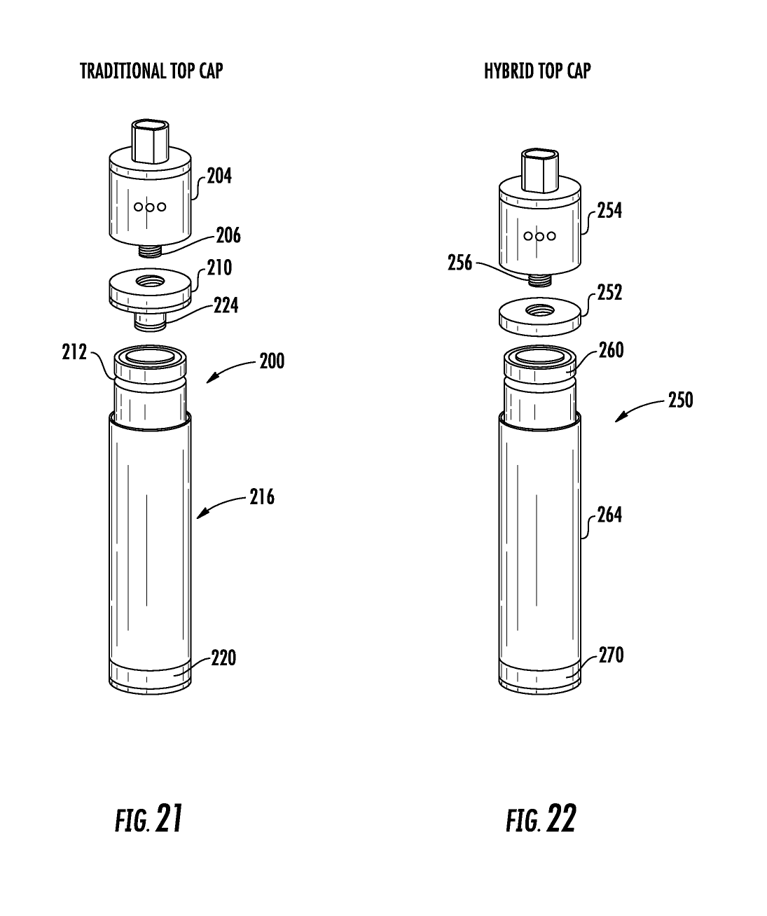

The housing 34 formed of the female tube member 38 and male tube member 36 and button assembly 40 as the switch may also be referred to as a personal vaporizer “mod” device as noted before, while without the button assembly, the housing as the male and female tube members could be referred to as the personal vaporizer mod device housing. It should also be understood that the RDA as described and the button assembly as described above and in greater detail below could be used with a one-piece housing. There are a number of hybrid mods as mechanical mods where the top cap comes off. There are one-piece units and FIG. 21 shows a traditional top cap personal vaporizer at 200 as an electronic cigarette that shows the atomizer 204 and the atomizer 510 pin 206 and the traditional top 210 that connects directly to the battery 212 as part of the “mod” device shown at 216, which includes a switch 220 at the bottom and operates as a mechanical device containing no circuitry or electronic component such as a microprocessor. This traditional connection has the atomizer screw 206 threading into the top cap 210, which also includes a pin 224 that typically is threaded extends downward to contact the battery 212 and create a buffer between the two. A user would find that this type of “mod” would hit more softly than hybrid mods 250 such as shown in the example of FIG. 22. In that example, the hybrid top cap 252 receives the atomizer 254 via its atomizer 510 connection 256 so that the 510 pin 256 will screw directly and contact the battery 260 received within the mod 264 and the circuit completed by activating the bottom switch 270 in this example. The hybrid top cap 252 allows a vaping atomizer such as illustrated at 254 to be directly connected to the battery 260 and provide a direct connection that allows for better power transfer and a harder, faster hit. The traditional mods 200 such as shown in FIG. 21 use a top cap 210 with two adjustable “positive” points with one point to the atomizer that is usually smaller or the same size as the atomizer pin and the other point to the battery. An insulator separates that positive pin from the rest of the mod. Thus, there is less chance of shorting out.

An unsafe hybrid set up of the mode device type shown in FIG. 22 would have the atomizer and its positive pin flush with its negative portion or pin and allow the negative pin to touch the battery positive contact and possibly causing flash or burning. In a safe hybrid set up, the atomizer's positive pin would protrude past its negative outer edges that is the threaded negative portion of the 510 connection such that the threads and that whole outer section is negative. Between the positive pin and negative threads is a plastic or other insulator that separates the negative from the positive. Thus, the safe hybrid would have the positive pin protruding past the negative portion to prevent the negative portion from touching the battery's positive contact. Usually these type of mods may use a conventional 18650 battery that may vent and release the pressure. Thus, they include vent holes.

The personal vaporizer 30 as an electronic cigarette described above relative to FIGS. 1-20 can be referred to as a hybrid mod since the RDA assembly 32 will thread via what is termed the conventional 510 connection via a centrally located threaded orifice 38a onto the substantially planar upper end as a top flat portion 38b of the female tube member 38, which is part of the housing 34 and includes the male tube member 36. The bottom portion of the RDA deck 44 seats on top of the flat or planar upper end 38b of the female tube as a “sleeve” or “hybrid sleeve,” which receives the male tube member 36.

Referring to FIG. 23, there is shown the personal vaporizer as the electronic cigarette 30 that includes in this figure a top cap 150, also termed a drip tip that is contained over the RDA subassembly 32 and engages the female tube member 38 as the hybrid sleeve. The housing 34 and the switch as a button assembly 40 together may be considered as a personal vaporizer mod device and the housing as a personal vaporizer mod device housing.

A better view of the switch as a button assembly 40 is illustrated in FIG. 23 and shows the one-piece button member 40c received within a first orifice section 41a of the button housing 40a and has the firing pin 40b screwed onto an extension formed as a pin or threaded shaft 40e of the button member that extends into a second orifice section 41b of the button housing. The shaft 40e receives thereon the firing pin 40b. As illustrated, the first orifice section 41a has a first diameter and the second orifice section 41b has a second diameter less than that first diameter. An annular well 40f is formed within the button member to form a slightly larger diameter button hub 40g than the shaft 40e and receives a first circumferentially configured magnet 40h of a first polarity. This annular well 40f has a diameter almost as large as the diameter of the button member 40c to form a thin annular wall portion. The button housing may be referred to as a switch housing 40a of the button assembly 40 and has an internal annular slot or groove 40i in the second orifice section 41b that receives at least one circumferentially configured magnet having a polarity opposite the polarity of the first magnet 40h, and in this example, two magnets 40j that are the same polarity but both of opposite polarity from the first circumferentially configured magnet 40h.

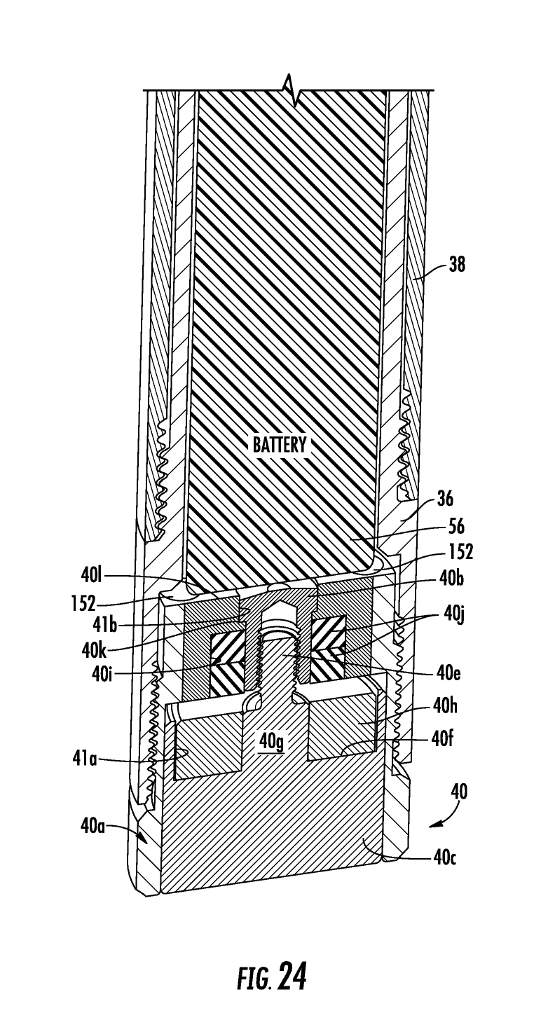

The button housing 40a is threaded into the bottom section of the male tube member 36 as illustrated and the firing pin 40b is threaded onto the extension or shaft 40e of the button member 40c as a one-peace button. A first pin stop 40k is formed in the button housing 40a and engages the firing pin 40b and prevents further movement of the button member 40c rearward out of the button housing and retains the button member within the button housing. In an example, the firing pin stop 40k is formed as a button housing shoulder formed on the button housing 40a within the second orifice section 41b. The firing pin 40b includes a firing pin head 43a having a lower annular ridge 43b (FIGS. 25 and 26) that engages the button housing shoulder 40k.

As a result, when the firing pin 40b is threaded onto the threaded shaft 40e of the button member 40a, it holds the magnets 40h, 40j in place, while also allowing the magnetic force of opposite polarity to force the magnet 40h away from magnets 40j and driving the button member downward. This permits a gap to exist between the opposing magnets 40h, 40j and the button housing 40a and button member 40c, allowing the button member to be depressed and move the firing pin upward into contact with a battery contact. Also, the firing pin 40b can be adjusted in distance or height. When the button assembly 40 is threaded and received into the bottom section of the male tube 36, it engages at the top or upper circumferential surface 401 of the button housing 40a a series of pads or stand-offs 152. These stand-offs 152 may be formed of different material, such as an insulator, and provide a spacer around the top or upper circumferential surface of the button housing 40a and engage the lower end of the battery 56 to provide a gap between the firing pin 40b and the lower end of the battery via the stand-offs 152. Thus, the one-peace button 40c may be depressed, forcing the firing pin 40b upward to make contact with the negative end of the battery 56 and complete the electrical connection to the RDA subassembly 32.

The button member 40c includes an outer planar surface that the user depresses as best shown in FIGS. 24 and 29. In a preferred example, this outer planar surface includes an ornamental design formed thereon. In the three-piece button example of FIG. 29, the ornamental design is a butterfly. As best illustrated also in FIG. 24, the button housing 40a includes a first section received within the lower end of the male tube member 36 preferably by threaded connection and a second or lower section extends out of the lower end of the male tube member. The lower end of the male tube member 36 and first section of the button housing 40a include respective threads. When the button housing 40a is secured within the lower end of the male tube member 36, it may be turned and screwed upward to force the battery 56 upward to engage the atomizer pin 68 of a rebuildable atomizer deck such as the RDA subassembly 32. This allows some adjustment to prevent battery “rattle.”

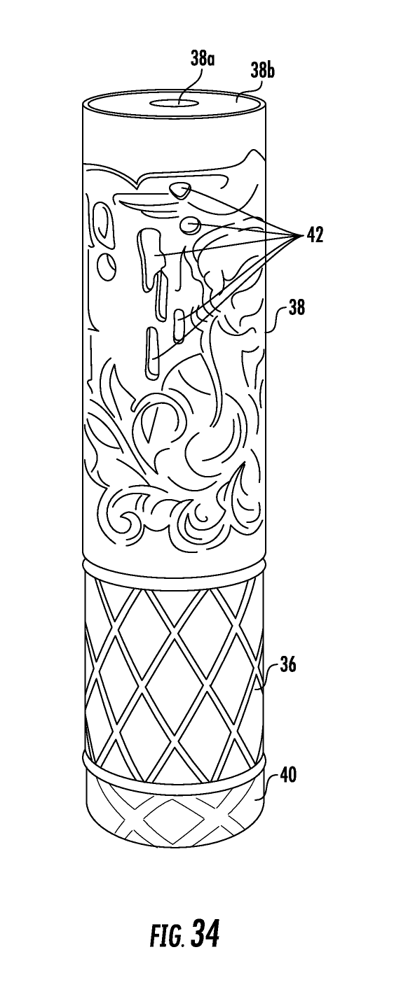

The outer diameter of the lower portion of the button housing 40a that is exposed and not received in the lower end of the male tube member 36, the lower portion of the male tube member that is exposed below the lower end of the female tube member 38, and the outer exposed surface of the female tube member are all about substantially the same diameter to each other, and thus, maintain a smooth appearance or at least a similar diameter appearance such as shown in FIGS. 33 and 34 as examples of a “mod” device for the personal vaporizer as an electronic cigarette. The lower end of the male tube member 38 has a ridge that abuts against the female tube member 36 (FIG. 24) and the exposed surfaces have about the same diameter.

Examples of the firing pin 40b are shown in FIGS. 25 and 26. The end of the firing pin (FIG. 25) that engages the battery has a substantially square configuration as the firing pin head 43a and round contact point that engages the negative terminal of the battery. The firing pin head 43a is formed with an underlying lower annular ridge 43b that engages the button housing shoulder 40k (FIG. 24), and thus, prevents the button member from falling out of the button assembly. The end view of the firing pin 40b of FIG. 26 shows a threaded opening so that the firing pin 40b can be screwed onto the extension or shaft 40e of the button member 40c. The firing pin 40b can be formed of copper or silver or other conductive materials. The personal vaporizer may be compatible with 18650 and 20700 batteries.

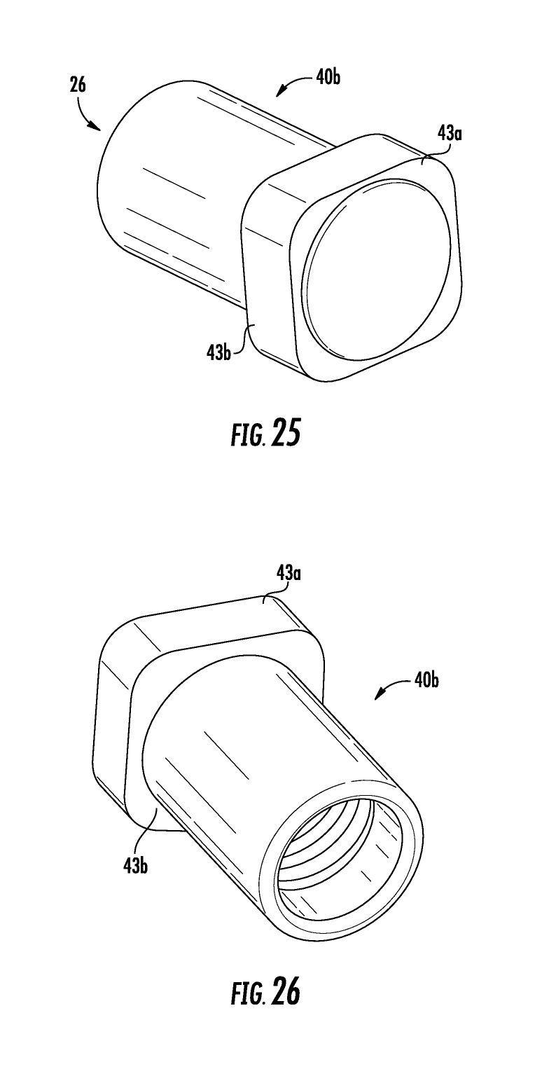

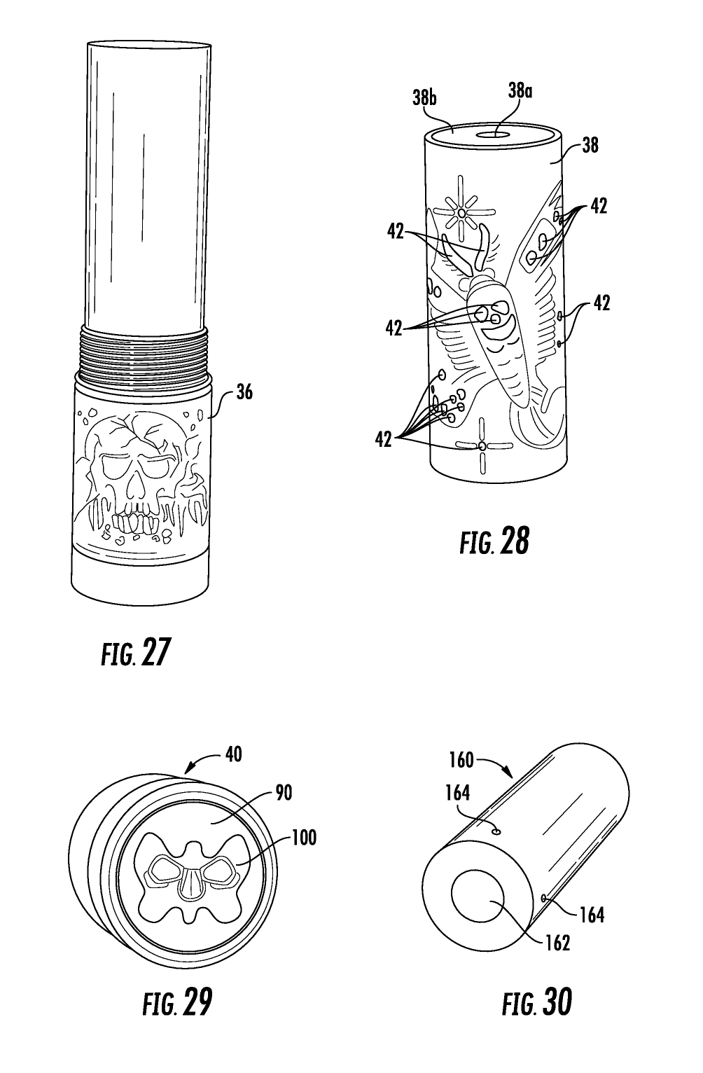

Referring now to FIGS. 27-29, there are illustrated figures of portions of a “Purge®” mod known as the “Pandora” edition. As shown in FIG. 27, the male tube member 36 has a lower portion with a distinct design and the upper section may have a distinct coloration. The decorative design on the lower portion of the male tube member 36 is exposed once the male tube member is screwed into the female tube member 38 shown in FIG. 28, which includes a specific ornamental design configuration and a distinct set of orifices or openings 42 forming a specific design. The button assembly 40 as shown in FIG. 29 includes a three-piece button member and shows the intermediate ring member 90 that is interposed between a base member (not shown) and button screw member 100 that is configured as a butterfly such as shown in FIGS. 19E and 19F. The intermediate ring member 90 could be formed of the plastic material such as described before and have different colorations and ornamental effects molded into it.

Referring now to FIG. 30, there is shown a battery adapter 160 or battery sleeve, which may receive a battery of different size than normally used and which may not fit comfortably within the male tube member 36. Different batteries can be accommodated by a selected size battery adapter as a battery sleeve, such as for a 18650 battery, which includes a contact 162 at the end with vent holes 164 at the bottom. The battery adapter or sleeve may be received within the male tube member 36. Because the button housing 40a is threaded into the lower end of the male tube member 36, its top portion presses up against the battery (or battery adapter) via the stand-offs 152 and pushes the positive pole of the battery upward into the contact screw 68, also termed the 510 pin, and helps prevent battery “rattle.” As noted before, the personal vaporizer may be compatible with 18650 and 20700 and other batteries.

This female tube member 38 as a sleeve-top cap design or hybrid sleeve, as it is also termed, is an excellent design that allows the ornamental effects to be enhanced via deep colors on the upper portion of the male tube member 36 that are exposed via the orifices or openings 42 in the female tube member 38 for ornamental effects and designs such as shown in FIG. 28. These openings 42 may also function as vent holes. Artwork of different designs can be CNC machined deep into the tube. The button assembly 40 as described before includes the strong magnets, which in this case are the three strong magnets as described with two of them having one polarity and the larger one in the annular well 40f or recess having opposite polarity to provide a comfortable throw and a good “hit.” The contact pin 68 could be formed of a silver or copper material in an example. In this non-limiting example, the “mod” device is a 26 mm body with a female tube member 38 that tapers to 25 mm at the top.

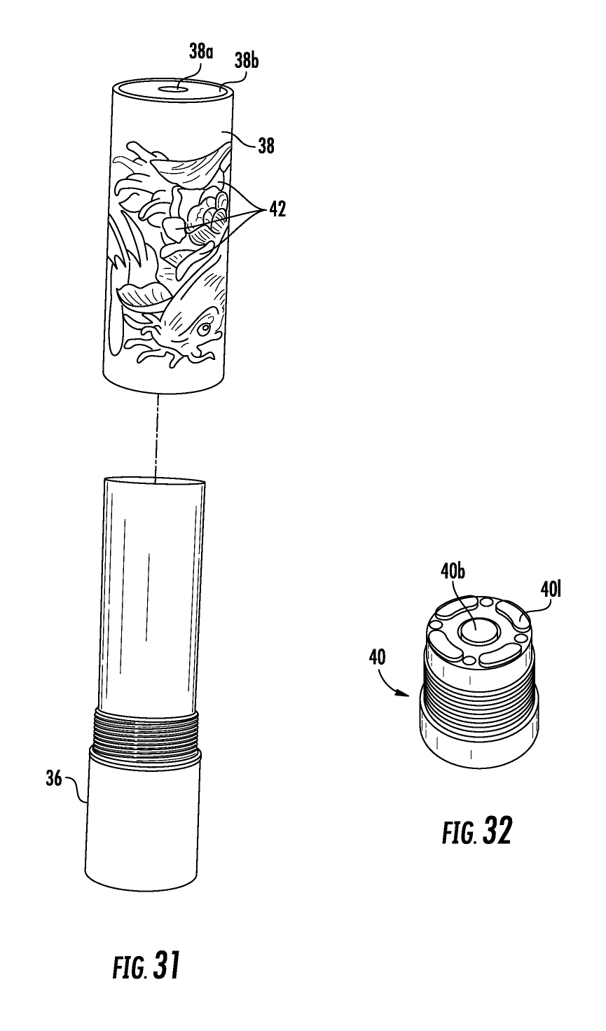

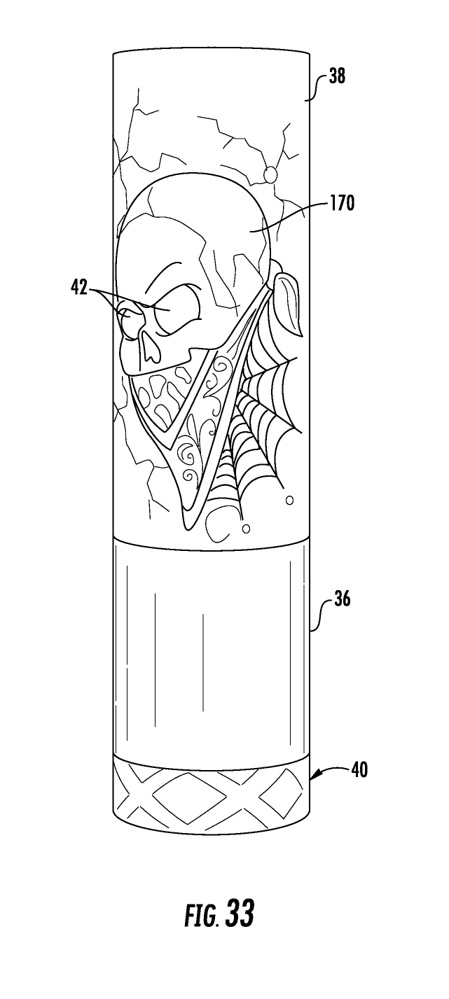

Referring now to FIGS. 31 and 32, there is shown a different housing 34 with the female tube member 38 disassembled from the male tube member 36 (FIG. 31) and showing the top surface of the button assembly 40 (FIG. 32) and its firing pin 40b located in the center. The female tube member 38 in this example has a different ornamental configuration for its openings 42 and a different surface configuration and design. A swirl design extends along the lower section that is exposed on the male tube member 36 and on the lower exposed section of the button assembly 40. Vent holes may be formed in the housing.

FIG. 33 shows yet another design of a “mod” device and a skull 170 formed on the surface of the female tube 38 and the holes or orifices 42 where the skull eyes are located to enhance the ornamental appearance of the skull design and enhance the openings as the eyes of the skull with the colored interior portion of the male tube member.

FIG. 34 is yet example of a “mod” device showing a different ornamental design on both the exposed portions of the male and female tubes 36, 38 and a configuration of openings or orifices 42 in the female tube 38 for decorative effect. The design using the “hybrid sleeve” as the female tube member that receives the male tube member permits a 510 connection as described above corresponding to the normal 5 mm and 10 threads that run along them, and thus, any normal RDA subassembly may be secured onto the “mod” device.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that the modifications and embodiments are intended to be included within the scope of the dependent claims.

That which is claimed is:

1. A personal vaporizer mod device, comprising:
a cylindrical housing comprising a female tube member formed of a metallic material and having a first closed end and opposing open end and a male tube member formed of a metallic material and received within the female tube member, wherein the first closed end of the female tube member has a substantially planar upper end and a medially located orifice configured to receive an atomizer pin of a rebuildable atomizer deck that is supported on the planar upper end of the female tube member, wherein the male tube member has open opposing ends and an upper end that is received within the female tube member and lower end extending out the female tube member, wherein the male tube member is configured to receive a battery having a battery contact that engages the atomizer pin for supplying electric current to the rebuildable atomizer deck for atomizing a vaping liquid; and
a switch at the lower end of the male tube member which when closed, completes an electrical circuit from the battery into the male and female tube members and into the rebuildable atomizer deck, said switch comprising a button housing received within the lower end of the male tube member and having a first orifice section of first diameter, and second orifice section of a second diameter less than the first diameter, and a button member received within the first orifice section, said button member having a shaft extending into the second orifice section and a firing pin received on the shaft that engages a battery contact of the battery when the button member is depressed, the button member further comprising an annular well and first magnet of a first polarity received therein, wherein the button housing includes an internal annular groove in the second orifice section and at least one second magnet therein and having a polarity opposite the first magnet such that the button member is repelled in a direction outward from the button housing, and a firing pin stop formed in the button housing that engages the firing pin and retains the button member within the button housing.

2. The personal vaporizer mod device according to claim 1, further comprising standoffs positioned on the button housing that engage a battery received within the male tube member and create a gap between a battery contact and the firing pin.

3. The personal vaporizer mod device according to claim 1, wherein said button member comprises a three-piece button member comprising:
a base member having an orifice and an extension that receives the firing pin;
a button screw member comprising a head having a predetermined configuration and shaft extending therefrom and received within the orifice in the base member; and
an intermediate ring member interposed between the base member and the button screw member and including a slot having a configuration to match and receive the head of the button screw member.

4. The personal vaporizer mod device according to claim 3, wherein the base member and button screw member are formed of a metallic material and the intermediate ring member is formed from a plastic material.

5. The personal vaporizer mod device according to claim 3, wherein the female tube member has openings that are configured to expose portions of the male tube member.

6. The personal vaporizer mod device according to claim 5, wherein the female tube member has a design formed on its surface and the openings are configured in size and position to complement the design.

7. The personal vaporizer mod device according to claim 6, wherein the design formed on the surface comprises a skull and the openings correspond to the eyes of the skull.

8. The personal vaporizer mod device according to claim 1, wherein the lower end of the male tube member abuts against the female tube member and has an outer diameter about the same as the outer diameter of the female tube member.

9. The personal vaporizer mod device according to claim 1, wherein the firing pin stop comprises a button housing shoulder formed on the button housing within the second orifice section, and said firing pin includes a firing pin head having a lower annular ridge that engages the button housing shoulder.

10. The personal vaporizer mod device according to claim 1, wherein the firing pin stop is configured such that a gap exists between the button housing and button member, allowing the button member to be depressed and move the firing pin upward into contact with a battery contact.

11. The personal vaporizer mod device according to claim 1, wherein the at least one second magnet comprises two stacked magnets retained within the internal annular groove.

12. The personal vaporizer mod device according to claim 1, further comprising a battery adapter received within the male tube member and including a battery contact to which the firing pin engages when the button member is depressed.

13. The personal vaporizer mod device according to claim 1, wherein said button member includes an outer planar surface that a user depresses, said outer planar surface including an ornamental design formed thereon.

14. The personal vaporizer mod device according to claim 1, wherein said button housing includes a first section received within the lower end of the male tube member and a second section that extends out of the lower end of the male tube member.

15. The personal vaporizer mod device according to claim 14, wherein the lower end of the male tube member and first section of the button housing include respective threads, and the button housing when secured within the lower end of the male tube member forces a battery upward to engage the atomizer pin of a rebuildable atomizer deck.

16. A button assembly operative as a switch for a personal vaporizer mod device housing, comprising:
a button housing having a first section configured to be received within the lower end of a male tube member of a personal vaporizer mod device housing, and a second section that extends out of the lower end of the male tube member, said button housing having a first orifice section of first diameter and second orifice section of a second diameter less than the first diameter;
a button member received within the first orifice section, said button member having a shaft extending into the second orifice section and a firing pin received on the shaft that engages a battery contact of a battery when the button member is depressed, the button member further comprising an annular well and first magnet of a first polarity received therein; and
wherein the button housing includes an internal annular groove in the second orifice section and at least one second magnet therein and having a polarity opposite the first magnet such that the button member is repelled in a direction outward from the button housing, and a firing pin stop formed in the button housing that engages the firing pin and retains the button member within the button housing.

17. The button assembly according to claim 16, further comprising standoffs positioned on the button housing that engage a battery received within the male tube member and create a gap between a battery contact and the firing pin.

18. The button assembly according to claim 16, wherein said button member comprises a three-piece button member comprising:
a base member having an orifice and an extension that receives the firing pin;
a button screw member comprising a head having a predetermined configuration and shaft extending therefrom and received within the orifice in the base member; and
an intermediate ring member interposed between the base member and the button screw member and including a slot having a configuration to match and receive the head of the button screw member.

19. The button assembly according to claim 18, wherein the base member and button screw member are formed of a metallic material and the intermediate ring member is formed from a plastic material.

20. The button assembly according to claim 16, wherein the firing pin stop comprises a button housing shoulder formed on the button housing within the second orifice section, and said firing pin includes a firing pin head having a lower annular ridge that engages the button housing shoulder.

21. The button assembly according to claim 16, wherein the firing pin stop is configured such that a gap exists between the button housing and button member, allowing the button member to be depressed and move the firing pin upward into contact with a battery contact.

22. The button assembly according to claim 16, wherein the at least one second magnet comprises two stacked magnets retained within the internal annular groove.

23. The button assembly according to claim 16, wherein said button member includes an outer planar surface that a user depresses, said outer planar surface including an ornamental design formed thereon.

24. A personal vaporizer mod device housing, comprising:
a female tube member formed of a metallic material and having a first closed end and opposing open end;
a male tube member formed of a metallic material and received within the female tube member;
wherein the first closed end of the female tube member has a substantially planar upper end and a medially located orifice configured to receive an atomizer pin of a rebuildable atomizer deck that is supported on the planar upper end of the female tube member; and
wherein the male tube member has open opposing ends and an upper end that is received within the female tube member and lower end extending out the female tube member, wherein the male tube member is configured to receive a battery having a battery contact that engages an atomizer pin of a rebuildable atomizer deck that is supported on the planar upper end of the female tube member for supplying electric current to the rebuildable atomizer deck and atomizing a vaping liquid, and the lower end of the male tube member is configured to receive a switch, which when closed, completes an electrical circuit from a battery into the male and female tube members and into the rebuildable atomizer deck supported on the female tube member.

25. The personal vaporizer mod device housing according to claim 24, wherein the female tube member has openings that are configured to expose portions of the male tube member.

26. The personal vaporizer mod device housing according to claim 24, wherein the female tube member has a design formed on its surface and the openings are configured in size and position to complement the design.

27. The personal vaporizer mod device housing according to claim 26, wherein the design formed on the surface comprises a skull and the openings correspond to the eyes of the skull.

28. The personal vaporizer mod device housing according to claim 24, wherein the lower end of the male tube member abuts against the female tube member and has an outer diameter about the same as the outer diameter of the female tube member.
